(19) United States
(12) Patent Application Publication
(10) Pub. No.: US 2024/0202223 A1
(43) Pub. Date: Jun. 20, 2024

(54) METHODS FOR ITERATIVE BATCHING OF FIGURES VIA USER SET PARAMETERS AND SYSTEMS FOR SAME

(71) Applicant: Becton, Dickinson and Company, Franklin Lakes, NJ (US)

(72) Inventors: Leslie Wilson, Ashland, OR (US); Zachary Wentworth, Medford, OR (US); John Quinn, Yardley, PA (US)

(21) Appl. No.: 18/537,031

(22) Filed: Dec. 12, 2023

Related U.S. Application Data
(60) Provisional application No. 63/431,867, filed on Dec. 12, 2022.

(51) Int. Cl. G06F 16/34; G01N 15/14; G01N 15/1429; G06F 16/54

(52) U.S. Cl. CPC G06F 16/34; G01N 15/1429; G06F 16/54; G01N 2015/1402

(57) ABSTRACT

Aspects of the present disclosure include methods, systems and non-transitory computer readable storage mediums for automatically generating reports based on, e.g., flow cytometric data. Methods of for automatically generating reports according to certain embodiments include: generating, based on input from a user, a report template, selecting, based on input from the user, a source group and an iterator type, wherein the source group comprises a plurality of data sets, and the iterator type corresponds to a type of data present in the source group, and iteratively populating a plurality of batch reports using the plurality of data sets of the source group, based on the iterator type, wherein each batch report conforms to the report template and is populated with a separate data set of the plurality of data sets of the source group. Aspects of the present disclosure further include methods of automatically generating reports, where such reports comprise one or more of an image, a plot, a chart, a table, a legend or text and are populated with data from one or more data sets. Systems for practicing the subject methods are also provided. Non-transitory computer readable storage mediums are also described.

### CROSS-REFERENCE TO RELATED APPLICATION

Pursuant to 35 U.S.C. § 119 (e), this application claims priority to the filing date of U.S. Provisional Patent Application Ser. No. 63/431,867 filed Dec. 12, 2022; the disclosure of which application is incorporated herein by reference in its entirety.

### INTRODUCTION

Flow-type particle detection and analysis systems, such as flow cytometers, are used to detect, analyze and, in some cases, sort, particles in a fluid sample based on at least one measured characteristic of the particles. Visualization of data obtained from flow-type particle detection and analysis systems plays an important role in understanding, analyzing and characterizing collected data and finds use in, for example, biological and medical research.

Analysis of data obtained from flow-type particle detection systems may entail visualization of data, such as the display of plots of data. It is often useful to visualize multiple different aspects of a flow cytometric experiment, e.g., flow cytometric analysis of different samples. Using data visualization techniques for analyzing the underlying data, such as flow cytometry data, is useful for understanding and characterizing particles, such as cells, of a sample exposed to the particle detection system as well as, understanding and characterizing populations, or clusters, of particles of a sample.

In general, flow cytometry techniques facilitate the collection of very large data sets as well as very large numbers of data sets. Techniques for facilitating the presentation of such large data sets or large numbers of data sets are important for enabling the analysis of such data. Often such techniques require laborious, technical and repetitive overhead to visualize, or otherwise represent, in a systematic manner, such large data sets or large numbers of data sets.

### SUMMARY

Therefore, the inventors have realized that there is a need for yet continued improvement in data visualization techniques, such as techniques for processing and subsequently visualizing large data sets in a substantially automated manner. In particular, there remains a need for automatically generating reports that present data from a plurality of data sets, where each report is structured based on a single design or template. Embodiments of the present invention satisfy this need. Such need applies in particular with respect to flow cytometry data, in light of the large data sets as well as large numbers of data sets associated with flow cytometry experiments.

As described above, an advantage of flow cytometry is the ability to collect large data sets. Typically, users will have many data files and want to create reports on any number of varieties of data sets. Embodiments of the present invention enable this functionality by introducing novel techniques for generating reports for visualizing large data sets, such as flow cytometric data, more effectively and efficiently, in terms of minimizing and simplifying steps required of a user to generate reports and in terms of flexibility in presenting any number of data sets, types of data sets and configurations of reports based on such data sets, thereby improving the usefulness of data visualization techniques, in particular visualization of data collected via flow-type particle detection and analysis systems. Existing techniques in the art relate to text-based techniques that involve manual configuration of various fields for automatic population of data from spreadsheets, for example. Utilizing embodiments of the present invention for automatic report generation enables highly flexible and highly automated report generation that are not limited to text-based techniques.

Aspects of the present disclosure include methods, systems and non-transitory computer readable storage media for automatically generating reports based on, e.g., flow cytometric data. Methods of for automatically generating reports according to certain embodiments include: generating, based on input from a user, a report template, selecting, based on input from the user, a source group and an iterator type, wherein the source group comprises a plurality of data sets, and the iterator type corresponds to a type of data present in the source group, and iteratively populating a plurality of batch reports using the plurality of data sets of the source group, based on the iterator type, wherein each batch report conforms to the report template and is populated with a separate data set of the plurality of data sets of the source group. Aspects of the present disclosure further include methods of automatically generating reports, where such reports comprise one or more of an image, a plot, a chart, a table, a legend or text and are populated with data from one or more data sets.

Aspects of the present disclosure further include systems for practicing the subject methods. Systems for automatically generating reports according to certain embodiments comprise: a processor comprising memory operably coupled to the processor, wherein the memory comprises instructions stored thereon, which, when executed by the processor, cause the processor to: receive input from an input device specifying a configuration of a report template, generate, based on the configuration received from the input device, the report template, receive input from the input device specifying a source group and an iterator type, wherein the source group comprises a plurality of data sets, and the iterator type corresponds to a type of data present in the source group, iteratively populate a plurality of batch reports using the plurality of data sets of the source group, based on the iterator type, wherein each batch report conforms to the report template and is populated with a separate data set of the plurality of data sets of the source group, and outputting, to an output device, the plurality of batch reports to the output device, wherein the processor and the memory are operably connected to each of the input device and the output device.

Aspects of the present disclosure further include non-transitory computer readable storage medium comprising instructions stored thereon for practicing the subject methods. Non-transitory computer readable storage mediums according to certain embodiments include instructions comprising: algorithm for generating, based on input from a user, a report template, algorithm for selecting, based on input from the user, a source group and an iterator type, wherein the source group comprises a plurality of data sets, and the iterator type corresponds to a type of data present in the source group, and algorithm for iteratively populating a plurality of batch reports using the plurality of data sets of the source group, based on the iterator type, wherein each batch report conforms to the report template and is populated with a separate data set of the plurality of data sets of the source group.

### BRIEF DESCRIPTION OF THE FIGURES

The invention may be best understood from the following detailed description when read in conjunction with the accompanying drawings. Included in the drawings are the following figures:

FIG. 1 depicts examples of methods existing in the art for automatically populating text from a spreadsheet into a text document.

FIG. 2 presents an exemplary embodiment of a report template according to aspects of the present invention.

FIG. 3 illustrates a flow diagram of a method for automatically generating reports according to an embodiment of the present invention.

FIGS. 4A-C illustrate a flow diagram of a method for automatically generating reports according to another embodiment of the present invention.

FIGS. 5A-G illustrate a flow diagram of a method for automatically generating reports according to yet another embodiment of the present invention.

FIG. 6A-H illustrate a flow diagram of a method for automatically generating reports according to still another embodiment of the present invention.

FIG. 7 depicts a general architecture of an example computing device according to certain embodiments.

FIG. 8 shows an excerpt of a user interface for configuring aspects of an embodiment of the present invention.

FIGS. 9A-B show examples of generating a report template and using such template to automatically generate batch reports in a presentation according to an embodiment of the present invention.

### DETAILED DESCRIPTION

Aspects of the present disclosure include methods, systems and non-transitory computer readable storage mediums for automatically generating reports presenting, e.g., flow cytometric data. Methods of automatically generating reports according to certain embodiments include: generating, based on input from a user, a report template, selecting, based on input from the user, a source group and an iterator type, wherein the source group comprises a plurality of data sets, and the iterator type corresponds to a type of data present in the source group, and iteratively populating a plurality of batch reports using the plurality of data sets of the source group, based on the iterator type, wherein each batch report conforms to the report template and is populated with a separate data set of the plurality of data sets of the source group. Aspects of the present disclosure further include methods of automatically generating reports, where such reports comprise one or more of an image, a plot, a chart, a table, a legend or text and are populated with data from one or more data sets. Systems for practicing the subject methods are also provided. Non-transitory computer readable storage mediums are also described.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

The present disclosure provides methods for automatically generating reports. In further describing embodiments of the disclosure, methods that include generating, based on input from a user, a report template, selecting, based on input from the user, a source group and an iterator type, wherein the source group comprises a plurality of data sets, and the iterator type corresponds to a type of data present in the source group, and iteratively populating a plurality of batch reports using the plurality of data sets of the source group, based on the iterator type, wherein each batch report conforms to the report template and is populated with a separate data set of the plurality of data sets of the source group, are first described in greater detail. Next, systems to practice the subject methods are described. Non-transitory computer readable storage mediums are also described.

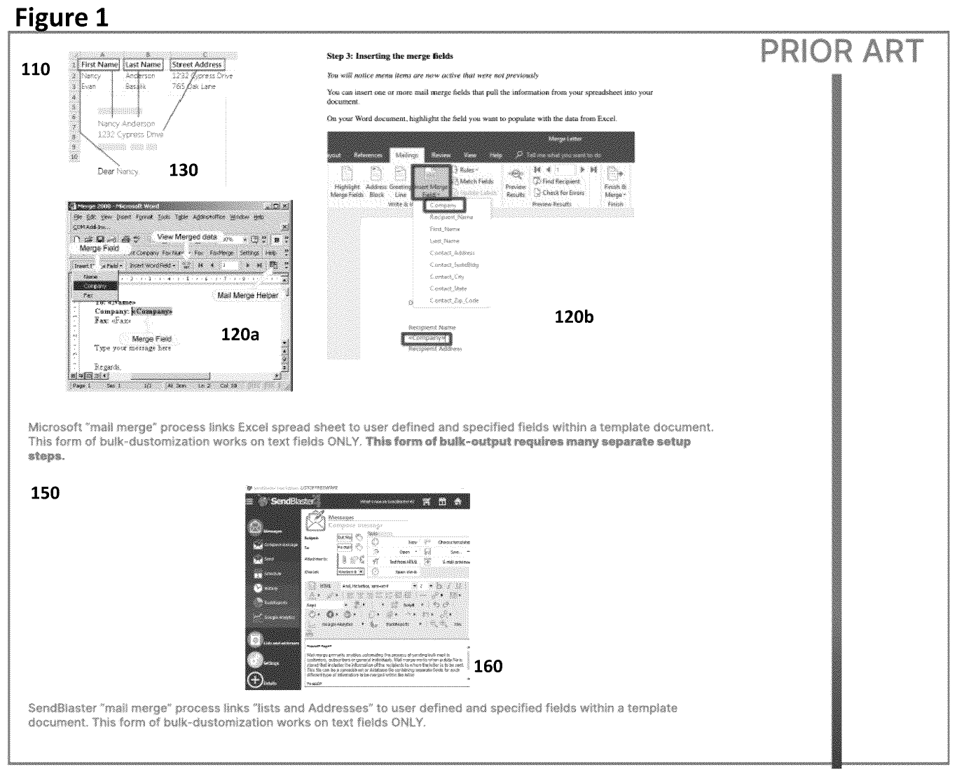

As described herein, the present invention is related to automatically generating reports, including by iteratively populating a plurality of reports using a plurality of data sets. In the prior art, a popular technique for automatically populating text within a template is Microsoft Word “mail merge,” which technique is used to populate fields of a template text document (i.e., a Microsoft Word document) using specified fields of a spreadsheet document (i.e., a Microsoft Excel document). An example of how such prior art automatically populates text from a spreadsheet into a text document is shown in FIG. 1. Mail merge process 110 involves specifying fields in a text document 120a, 120b. Specifying fields in a text document 120a, 120b involves, for example, tagging each field with information specifying the applicable data type to be input into such field. For example, a field in a text document may be specified as a “Name” field or a “Company” field. Upon activating mail merge, such specified fields of the text document are populated using text stored in a spreadsheet 130. That is, one or more mail merged documents are generated, in which each specified field 120 includes corresponding data from the spreadsheet 130.

A SendBlaster “mail merge” process 150 works similarly, where a text document 160 is annotated by a user to specific certain fields for automatic populating. SendBlaster “mail merge” process 150 further requires a user to specify a series of lists of addresses (not shown) for merging into text documents. Upon activation of the SendBlaster “mail merge” process, 150, one or more documents are generated with the specified text fields populated with relevant text from the lists of addresses.

In each such mail merge process 110, 150, a user is required to specifically highlight (i.e., annotate or “Insert a Merge Field” to designate a field) into the desired text document. In addition, such processes 110, 150 require a user to create a spreadsheet or the like that specifies or otherwise organizes the text to be populated into each text document in a specific format. That is, such processes 110, 150 require many separate, detailed and granular steps to set up an automatic populating process. Further, such techniques are applicable to text fields only. That is, documents are automatically populated with text data only.

As described herein, embodiments of the present invention do not require such detailed, granular set up and configuration in advance, instead allowing a user to generate a report template, designate it as batch-able (also referred to as iterable; i.e., for automatic population of relevant data sets), and, as a result of applying an embodiment of methods according to the present invention, any content in such report template that can be batched (i.e., automatically populated) will be batched. In embodiments, batching is governed by groups. In some instances, a group is a partition of the data files that can be set up a priori, with or without membership criteria. If set up without criteria, a user may add data to a group simply by dragging and dropping data files to it, thus determining which files will be batched without setup beyond the creation of the template. Alternately, a group may be created with criteria that will specify membership based on some attribute of the data. This attribute can be either inherent to the data, or annotated by the user at any point. In the prior case automatic assignment will result in delimitation of the files for batching without user input.

In addition, embodiments of the present invention are not limited to text only but instead are capable of automatically generating data analysis reports with pictorial representations of data, such as figures or plots, alone or in combination with text. Such improvements over the state of the art offered by embodiments of the present invention are discussed further herein.

### Methods

As summarized above, methods for automatically generating reports are provided. Methods for automatically generating reports according to certain embodiments include: generating, based on input from a user, a report template, selecting, based on input from the user, a source group and an iterator type, wherein the source group comprises a plurality of data sets, and the iterator type corresponds to a type of data present in the source group, and iteratively populating a plurality of batch reports using the plurality of data sets of the source group, based on the iterator type, wherein each batch report conforms to the report template and is populated with a separate data set of the plurality of data sets of the source group.

### Report Template:

In embodiments, a report template is generated by a user. That is, for example, a user may interact with a user interface of any convenient computer system to draft or otherwise configure a desired format for presenting data of interest. As described herein, reports of interest comprise reports presenting data sets collected from flow cytometrically analyzing one or more samples. In embodiments, a report template specifies one or more aspects of data to be presented in automatically generated reports. For example, a report template may specify a plot comprising a two-dimensional histogram of light intensity data corresponding to, for example, two different ranges of wavelengths of light that are of interest in connection with an experiment. Such a report template defines how data from available data sets will be subsequently populated into batch reports (i.e., automatically generated reports). That is, batch reports are automatically generated reports that are specific instances of a report template that include (present) a desired dataset.

In embodiments, the report template comprises a data visualization structure. By data-visualization structure, it is meant any convenient form of presenting data, including representing data pictorially, such as, for example, one or more of an image, a plot, a chart, a table, a legend or text. As described above, plots of interest may comprise a histogram, such as a two-dimensional histogram, presenting light intensity data corresponding to different aspects of light detected from flow cytometrically analyzing a sample. In embodiments in which the data visualization structure comprises an image, such image may be an image of a cell. For example, such image may specify an image of a cell, where such image is collected by an imaging flow cytometer, as described herein.

As described above, in embodiments of the present invention, report templates are generated by a user. In such cases, generating a report template may comprise receiving from the user a configuration of the data visualization structure. Such configuration or configurations may comprise an arrangement of one or more plots with associated variables of interest to be displayed along each axis of the plot based on the underlying data sets, such as flow cytometric data, to which the embodiment of the present invention is applied. In other cases, a configuration received from a user may comprise manipulating a plurality of data visualization structures, such as a plot with text associated with the plot or a table associated with a plot or an image associated with a plot. In embodiments, the report template comprises a basis for automatically generated reports, i.e., instances of the report template (batch reports) populated with data.

### Exemplary Embodiment of Report Template:

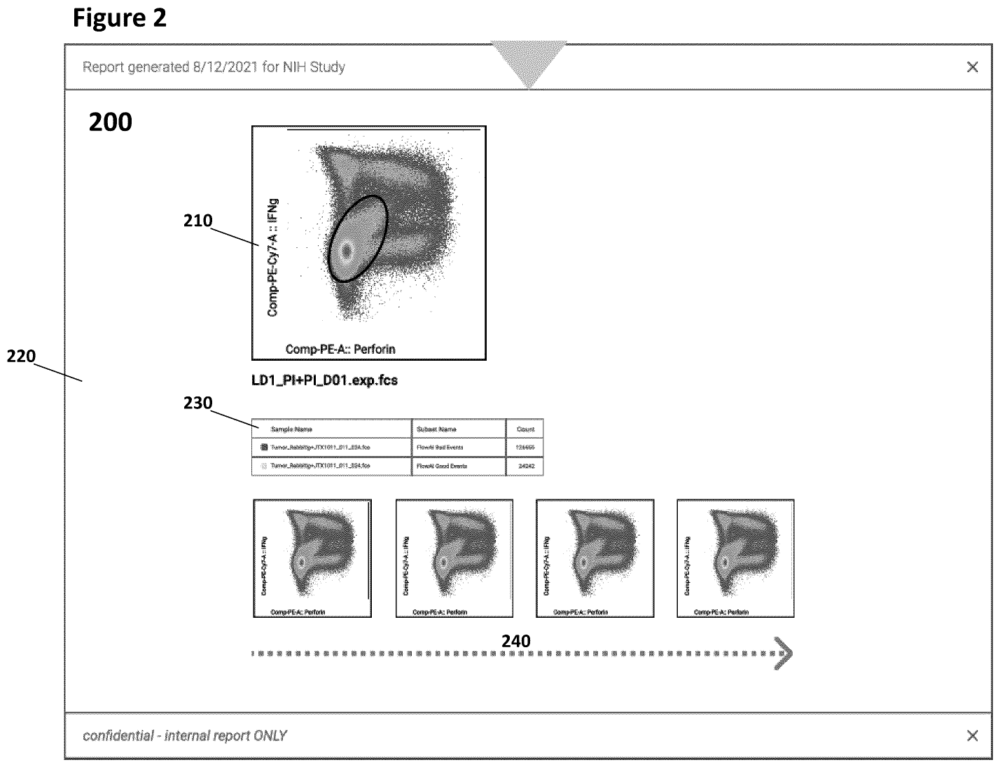

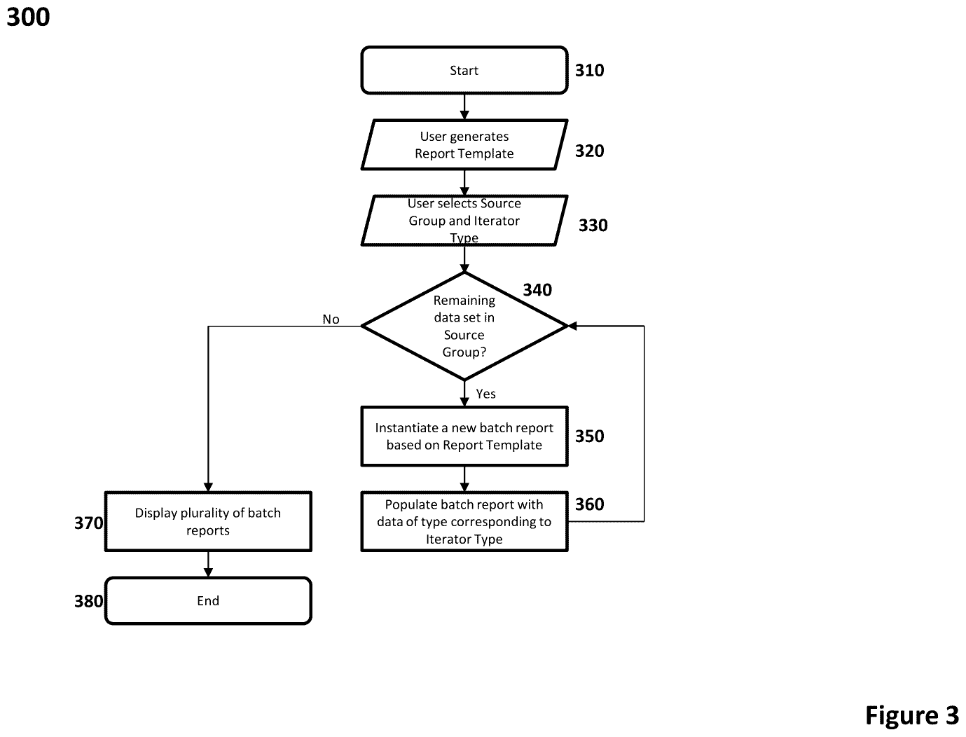

FIG. 2 presents an exemplary embodiment of a report template according to aspects of the present invention. Seen in FIG. 2 is report template 200 that includes plot 210. Plot 210 comprises a two-dimensional histogram with an x-axis and y-axis, each associated with different light intensity variables associated with a data set generated by flow cytometrically analyzing a sample of interest. Notwithstanding that plot 210 is a report template and therefore need not be populated with data, in this case, plot 210 presents flow cytometric data corresponding to a data set of the source group, e.g., of previously collected flow cytometric data. As described above, embodiments of methods of the present invention automatically determine which aspects of report template 210 are capable of being populated with data from the plurality of data sets of the source group. That is, in embodiments, by specifying report template 210 itself, the user specifies which fields of the report may be populated with data from each data set of the source group. Which data is ultimately populated into fields of report template 210 further depends on the selection by the user of a source group as well as an iterator type, as described herein.

As discussed further below, report template 200 is presented on presentation page 220. Presentation page 220 is a page designed by a user for organizing data to be presented to consumers of automatically generated reports. In the embodiment shown in FIG. 2, presentation page 220 includes legend 230 with characteristics about data sets (e.g., data about one or more samples) that are used to populate the automatically generated reports. Information provided about samples in legend 230 may comprise, for example, names of different biological samples analyzed with flow cytometry. Presentation page 220 further comprises a layout 240 of reports (i.e., batch reports, as described herein) that are automatically generated by application of an embodiment of methods of the present invention. Such layout 240 includes an annotated arrow indicating that such batch reports are generated, in part, by iteratively populating each such batch report using data from data sets of a source group. These 4 plots 240 represent iterated content from one specific sample, for example an ‘iterate by parameter’ or ‘iterate by population’ selecting sub-populations of the primary sample.

### Source Group:

Embodiments of methods of the present invention further comprise selecting, based on input from the user, a source group and an iterator type. In such embodiments, the source group comprises a plurality of data sets. That is, the source group may comprise multiple data sets, each corresponding to results of analysis of different samples using a flow cytometer. That is, each data set of the source group may comprise a different collection of flow cytometric data collected from, for example, flow cytometrically analyzing a different sample. Any convenient number of data sets may be specified in a source group, and such may vary. The number of data sets typically corresponds to aspects of an underlying experiment for which a flow cytometer is being used to analyze data and for which there is a desire to present results in the form of a collection of automatically generated reports (i.e., batch reports).

As described above, in certain embodiments, each data set of the source group comprises flow cytometric data. In such embodiments, the flow cytometric data may comprise light scatter or marker data or a combination thereof or any other data capable of collection via, for example, a flow cytometer. In some cases, the light scatter data comprises forward scattered light or side scattered light or a combination thereof. In other cases, the marker data comprises fluorescent light emission data. As described above, in embodiments, the flow cytometric data comprises data obtained from flow cytometrically analyzing a sample. In instances, each data set of the source group comprises flow cytometric data corresponding to a different sample. In some cases, each data set of the source group may comprise flow cytometric data corresponding to a different statistic associated with the underlying flow cytometric data. In certain instances, each data set of the source group may comprise flow cytometric data corresponding to different measurements derived from analyzing one or more samples using a flow cytometer. In some embodiments, each data set of the source group may comprise flow cytometric data corresponding to a different interval.

Embodiments of the present invention may further comprise receiving a data set of the source group. For example, such data sets may be received via an operable connection with any convenient flow cytometer system, or in other cases, such data sets may correspond to data sets collected from a flow cytometer at a different time and place, where such results are recorded in a non-transitory computer-readable storage medium in the form of, for example, an “.fcs” file or the like. In embodiments, selecting the source group comprises selecting a source group from a drop-down menu. That is, a source group, or aspects thereof, such as one or more data sets to include in the source group, may be selected by a user via any convenient user interface that comprises a list or other presentation of available source groups or aspects therein in the form of a drop-down menu or the like.

### Iterator Type:

In embodiments, the iterator type corresponds to a type of data present in the data sets of the source group. That is, the iterator type specifies what aspect (e.g., which variable or which type of data or the like) of each data set is to be presented in each automatically generated report according to methods of the present invention. For example, in the context of flow cytometric data, iterator types may specify a range of light intensity data for presentation on each instance of an automatically generated report (i.e., a batch report). In the context of the example report template 200 seen in FIG. 2, iterators may comprise data related to each of the x-axis and the y-axis of plot 210. In such example, the automatically generated plots (i.e., plots of the batch reports) present data on each x- and y-axis of each such generated plot corresponding to the iterator type for each data set of the source group.

In embodiments, aspects of the report template corresponding to each iterator type may be automatically identified. That is, a user may specify certain data as the iterator type and, as a result, embodiments of the present invention automatically identify an aspect of the report template associated with such iterator type. For example, in connection with the example report template 200 seen in FIG. 2, a user may specify in report template 200 data associated with light detected from flow cytometrically analyzing data and, based on this, the x- and y-axes of plot 210 may be identified as applicable to the selected iterator type for purposes of automatically generating a plurality of batch reports according to the present invention.

Further to automatically identifying aspects of the report template corresponding to the iterator type, embodiments of the present invention may rely on an underlying database or other form of storing data for presentation (e.g., results of flow cytometer experiments or the like) according to an analytical hierarchy. That is, data collected using a flow cytometer may be stored in a hierarchical manner, where such hierarchy enables appropriate selections of data from the stored data to be plugged into the appropriate place in each batch report. For example, FlowJo™ software from Becton, Dickinson and Company comprises a database displayed as an analysis hierarchy. Such hierarchical form of data storage divides relevant data into groups for functional purposes based on either meta information embedded in the raw data or a user's file as well as file system folder structure. Such hierarchical structure may be leveraged in embodiments to automatically populate relevant aspects of report templates with the relevant data from the data storage (comprising data sets of the source group). Additionally, in embodiments, users have an option to manually create additional groups comprising a hierarchical structure for use in automatically populating fields of a report template with the relevant, i.e., associated, data from such additional groups. In embodiments, automatically generating batched reports by iteration references this grouping structure. It is this aspect of hierarchical data storage that works to alleviate a need for any further tagging or labeling, as in tagging or labeling of a report template, analogous to the main merge applications discussed in connection with FIG. 1 above. Instead, in embodiments of the present invention, users pick from a fixed number of iterator types, and then any object placed on a page that is capable of being iterated over will be iterated. In other embodiments, users are able to lock objects such that they don't iterate or iterate under constraints, such as over limited data sets or the like. In embodiments, objects (e.g., figures, tables, legends, etc.) that the user has placed on the page via drag/drop to form a report template are themselves analogous to the tagged fields of the mail merge examples described above.

As described above, in embodiments, the iterator type identifies a category or type or aspect of data present in the source group. Examples of categories include results from analyzing samples by collecting light intensity data associated with ranges of wavelengths of interest, such as those associated with fluorescent markers or light scattering data of interest. In other instances, iterator types may identify a statistic of interest associated with data of a source group. Any convenient statistic may be utilized. Examples of such statistics include an average light intensity measured over a certain range, or maximum or minimum thereof, associated with each data set of a source group. In embodiments, the iterator type identifies a category of data that may vary across the plurality of data sets of the source group. In some embodiments, the iterator type selects the type of data used to populate the plurality of batch reports. That is, the iterator type directs which data from the data sets of the source group—i.e., which type of data, such as a range of measurements of light intensity or the like of each sample associated with a data set of the source group—is populated into, and therefore presented by, each batch report.

An intuitive example of an iterator type is iterating by sample. In this example, batch reports are generated by populating each instance of a report with data from one or a plurality of samples in a source group. However, embodiments of the present invention are not limited to setting an iterator type to sample, i.e., iterating by sample. Non-sample-based iteration is useful to allow a user, e.g., an experimenter, to select specific files to make a desired comparison, such as a desired biological comparison. In large cytometric experiments, there may be a diverse array of files that provide different functions and information. Screening by keyword or statistic, for example, allows for the user to efficiently include only the information relevant for the desired comparison.

Additionally, embodiments may provide a greater array of comparisons that allow users to make comparisons across sub-populations or top-level populations, in each case related to one or more samples. In embodiments, the formatting and appearance of the report page, i.e., the batched report, will be constant regardless of iteration or iterator type, but the content of each batch report will be affected, i.e., because different data sets are used to populate each batch report.

In some cases, the iterator type selects the type of data that varies across the plurality of batch reports: each batch report, being an instance of a report template, is identical in all respects except those respects corresponding to the iterator type, which instead vary according to the data in the data sets of the source group. In certain embodiments, batch reports are iteratively populated by iterator type. In instances, iterative populating may be viewed as a loop that is cycling through each data set of the source group, extracting data corresponding to the iterator type for presentation in a corresponding batch report. In this example, the number of batch reports may correspond to the number of data sets in the source group.

In embodiments, the iterator type determines whether batch reports are iteratively populated by sample, by keyword, by statistic or by interval.

When the iterator type corresponds to sample, data from each data set of the source group (i.e., each sample, about which cytometric data are collected) is populated in each batch report. That is, in embodiments, iteratively populating batch reports by sample comprises iterating over samples of the source group.

When the iterator type corresponds to keyword, keyword data from the data sets of the source group, is populated in each batch report. That is, in embodiments, iteratively populating batch reports by keyword comprises iterating over keywords of the source group. As described above, a user may make a selection of an iterator type, after which the user is presented with options related to such iterator type. For example, a user may select keyword as iterator type, after which the user is presented with potential keywords available to iterate over. While keywords are derived from, or otherwise associated with, the underlying data, the types of keywords offered for a user to include in a report template may comprise a standard selection of potential keywords.

When the iterator type corresponds to statistic, a specified statistic, e.g., one or more statistics summarizing or based on data from the data sets of the source group, is populated into each batch report. That is, in embodiments, iteratively populating batch reports by statistic comprises iterating over statistics of the source group. In embodiments, a user can specify a particular statistic of interest. As described above, a user may make a selection of an iterator type, after which the interface on which the user is working presents the user with options related to such iterator type. For example, a user may select statistic as iterator type, after which the user is presented with potential statistics available to iterate over. While such statistics are derived from the underlying data, the types of statistics offered for a user to include in a report template may comprise a standard selection of potential statistics. The choice of statistics may be based on what is most relevant to the underlying data being analyzed and presented, e.g., the underlying biological question being asked. Such underlying considerations vary from experiment to experiment and therefore require the user to specify on a per experiment basis the desired statistic.

When the iterator type corresponds to interval, an interval, e.g., one or more intervals present in the data sets of the source group, such as one or more periods of time during which flow cytometric data is collected, is populated in each batch report. That is, in embodiments, iteratively populating batch reports by interval comprises iterating over intervals of the source group. In embodiments, the user specifies an interval, which may be any desired interval, e.g., over which flow cytometric data about a sample is collected. Generating batched reports by interval (i.e., iterating by interval) suggests that there is a regular pattern within or among samples relevant to addressing an experimental question, such as addressing a biological question. Since such relevant intervals may vary based on the underlying experiment, in embodiments, the user would specify what that regular interval is.

Similar to the mechanism described above in connection with selecting source group data, in embodiments, selecting the iterator type comprises the user selecting an iterator type from a drop-down menu. Further, in embodiments, iterators available for use in connection with generating batched reports may be provided via a select list component of an interface, which presents all available iterator types to a user. Depending on the iterator chosen, other feature settings may become available via such interface.

### Presentation of Reports:

Embodiments of methods according to the present invention further comprise selecting a number of reports to include on a presentation page. That is, as described above, application of methods according to the present invention result in generating a plurality of batch reports, i.e., instances of a report template with real or meaningful data, such as previously collected flow cytometric data, reflected in the batch report. According to a user's preference, the user can specify how many such batch reports are presented on a single presentation page (e.g., presentation page 220 of FIG. 2). By presentation page, it is meant a document, into which the automatically generated batch reports are added, i.e., presented. Such presentation page may comprise a file, i.e., a collection data stored on a non-transitory computer readable storage medium, that reflects outputs of embodiments of methods according to the present invention where such outputs are user-facing or otherwise for user consumption. Exemplary presentation pages may comprise, for example, pages of a PowerPoint presentation or pages of a Portable Document File or the like. By selecting a number of reports to include on a presentation page, the user may select the number of pages over which the batch reports are spread. For example, a user may apply an embodiment of a method according to the present invention using a source group comprising 16 data sets, each corresponding to a different sample, and may specify to iterate by sample (i.e., set iterator type to sample) and further specify four automatically generated batch reports per presentation page. In such example, application of the embodiment of the present invention would result in automatic generation of 16 batch reports with four batch reports on each of four presentation pages.

In contrast to a batch report (which is automatically generated by application of an embodiment of methods according to the present invention) a presentation page may also comprise static content. Static content is any aspect, including data or a report or other content, of a presentation page that the user specifies is static content. Static content is not populated with data from the source group, instead remaining unchanged upon application of a method of the present embodiment. Both static content and batch-able content (i.e., batch reports or report templates) may be present on different pages of a presentation or even within a single presentation page.

### Exemplary Embodiments

FIG. 3 illustrates a flow diagram 300 of a method for automatically generating reports according to an embodiment of the present invention. Flow diagram 300 is an exemplary embodiment of the present invention provided for illustrative purposes. Flow diagram 300 is explained in terms of automatically generating reports related to flow cytometric data collected across a plurality of samples. Any convenient flow cytometric data, such as, for example, light scattering data or fluorescent marker data, related to any convenient samples, that are capable of being presented on a report (e.g., reports described above or illustrated by report 200 of FIG. 2), may be used to automatically generate reports by applying embodiments of the present invention, and such may vary. However, embodiments of the present invention are not so limited and may be used for automatically generating reports for collections of data sets other than flow cytometric data and/or other than flow cytometric data related to a plurality of different samples, as well.

Flow diagram 300 starts at step 310. From starting step 310, the process proceeds next to step 320.

At step 320, a user generates a report template. As described above, report templates of the present invention provide a structure used for presenting data of interest. Embodiments of a report template may be thought of as a receptacle into which selected data is input. However, report templates themselves do not represent an output of an embodiment of the present invention because, instead, report templates are used to guide the generation of instances of batch reports. As described above, batch reports, in contrast to report templates, are automatically generated and reflect different selected data from the data sets of the source group.

A user may generate a report template using any convenient techniques, such as manipulating and organizing data visualization structures via input and output devices of a computer system, such as those described herein. In embodiments, a user may generate a report template comprising, for example, a plot comparing one aspect of flow cytometric data, such as one type of fluorescent marker data, presented on an x-axis of the plot against another aspect of flow cytometric data, such as another type of fluorescent marker data, presented on a y-axis of the plot. In other examples, a plot generated by the user may compare an aspect of imaging flow cytometric data, such as eccentricity of imaged particles, presented on an x-axis of the plot, against a different spatial characteristic of imaging flow cytometric data, such as radial moment of imaged particles, presented on a y-axis of the plot. In general, plots, such as those described above, may present any convenient aspect of flow cytometric data. Further, report templates are not limited to one or more plots, but may include any convenient data visualization structure, such as an image (e.g., an image of a particle or cell), a chart, a table, a legend, text or the like. In such cases, the user may manipulate such data visualization structures as part of generating a report template, identifying what aspect of flow cytometric data are to be presented. For example, the user may specify that the report template comprises a chart presenting different summary statistics of different flow cytometric data.

In embodiments, report templates may comprise more than one data visualization structure and, further, may comprise a variety of data visualization structures.

Upon completion of generating a report template at step 320, flow diagram 300 next moves to step 330.

At step 330, the user selects a source group as well as an iterator type. As described above, a source group refers to a collection of data sets, such as a collection of data sets obtained by collecting flow cytometric data from a plurality of samples. In other cases, a collection of data sets making up a source group may comprise a plurality of different aspects of flow cytometric data obtained from a single sample, such as flow cytometric data from different time intervals or different detected light data or imaging data or any other aspect of flow cytometric data capable of detection using a flow cytometer, such as the flow cytometers described herein. In embodiments, any convenient technique may be applied to specify a source group. In some cases, data sets of a source group may be stored and manipulated as computer files, such that a source group is specified by compiling a collection of files, such as “.fcs” files. In other cases, a source group may be identified and selected using aspects of a user interface, such as, for example, a drop-down menu.

At step 330, the user also specifies an iterator type. As described above, an iterator type refers to the type of data selected and used to populate reports (i.e., the aspects of data sets that are input into each batch report). In embodiments, the user may specify that the iterator type corresponds to samples. In such case, data from different samples of flow cytometric data present in the source group is populated into each batch report. For example, in a case where the report template comprises a plot specifying two variables on x- and y-axes, the user may select iterator type to be samples, in which case, different batch reports will be automatically generated, each of which presenting the plot with the selected variables on the x- and y-axes showing data from different samples of the source group.

Upon completion of selecting a source group and iterator type at step 330, flow diagram 300 next moves to step 340.

At step 340, it is determined whether the source group comprises any data sets that have not yet been processed (i.e., used to generate a batch report). That is, in the first instance that flow diagram 300 encounters step 340, flow diagram 300 enters a control loop, in which each data set of the source group is processed (i.e., used to generate a corresponding batch report).

If there are data sets in the source group remaining to be processed, then flow diagram 300 next moves to step 350; if each data set in the source group has been processed, then flow diagram next moves to step 370.

At step 350, a new batch report is instantiated. By instantiating a new batch report, it is meant that the report template is copied or otherwise presented anew such that data from the applicable data set may be populated into such report. As described above, at step 340, flow diagram 300 entered into a control loop corresponding to the number of data sets included in the source group. Therefore, the number of batch reports (i.e., instantiations of report template) resulting from application of flow diagram 300 corresponds to the number of data sets in the source group. That is, application of step 350 over the course of the progress of flow diagram 300 results in one batch report corresponding to each data set of the source group.

Upon completion of instantiating a new batch report at step 350, flow diagram 300 next moves to step 360.

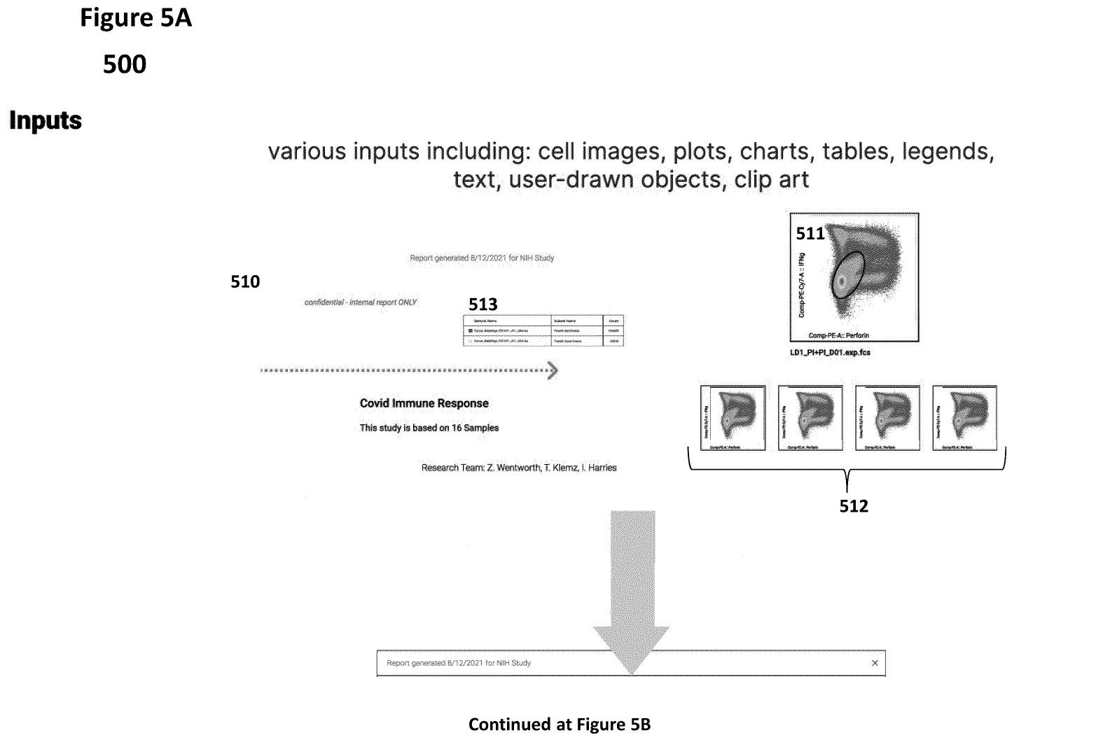

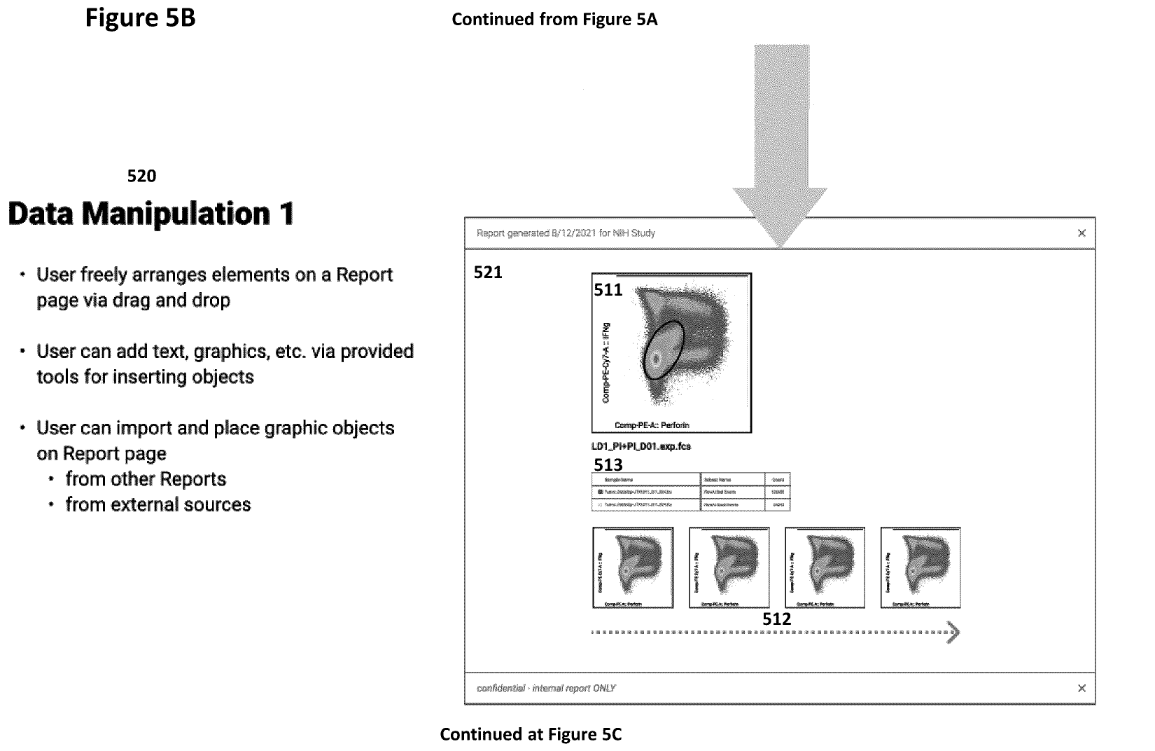

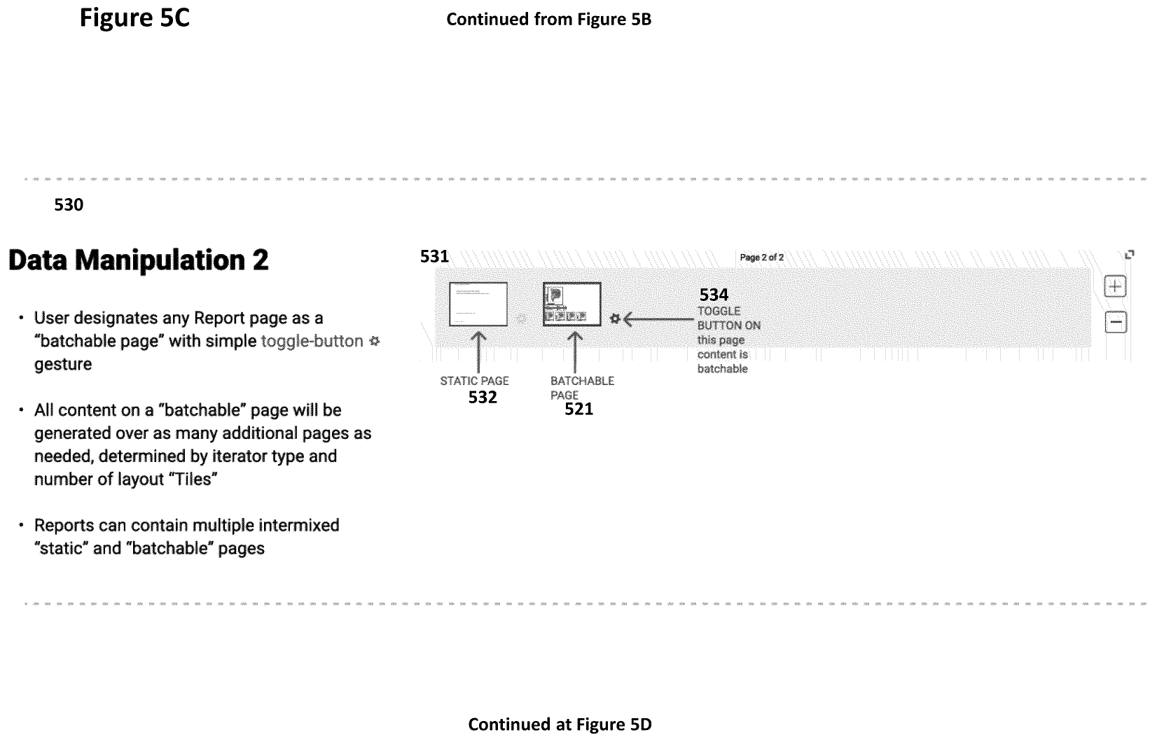

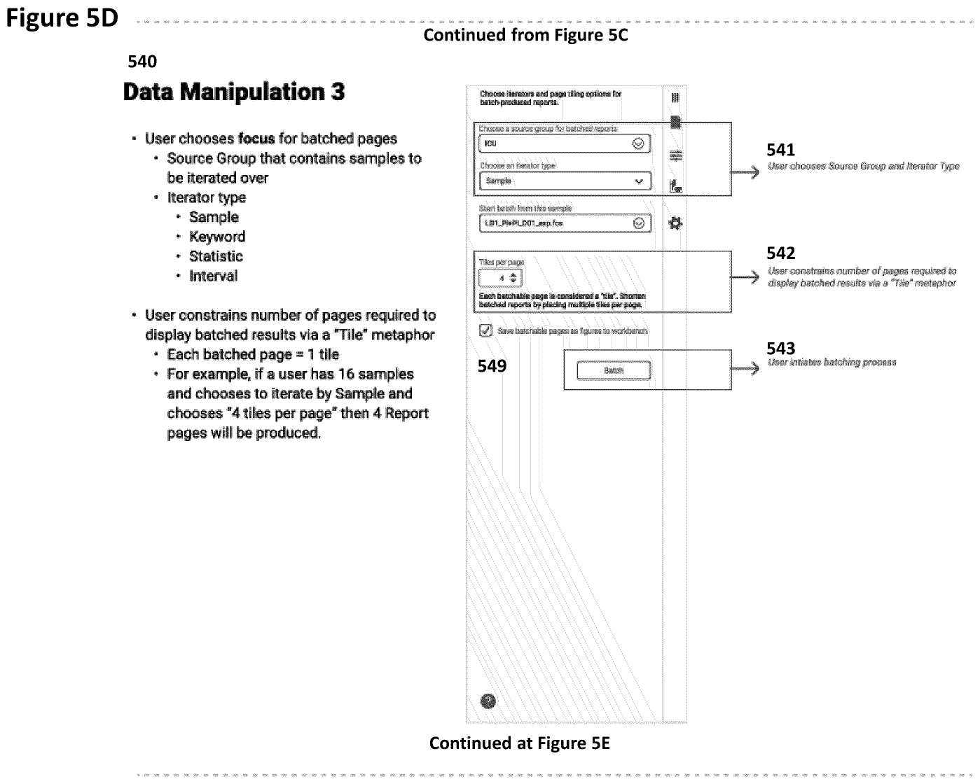

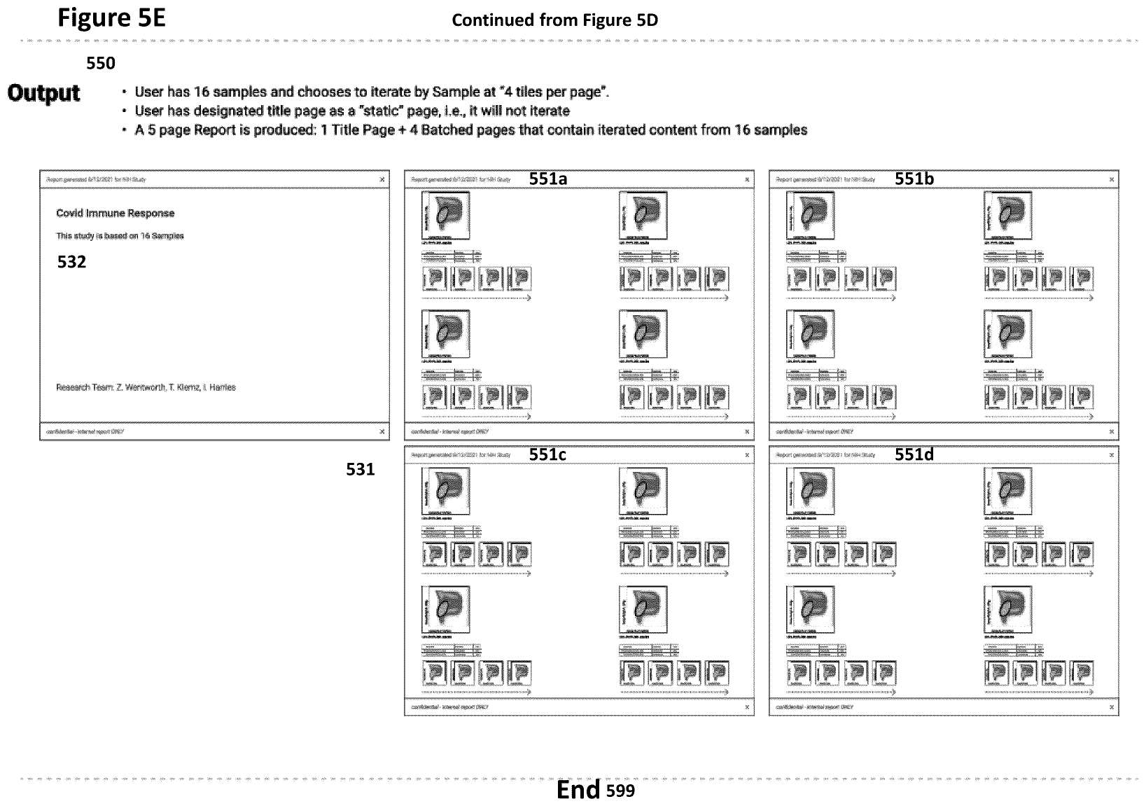

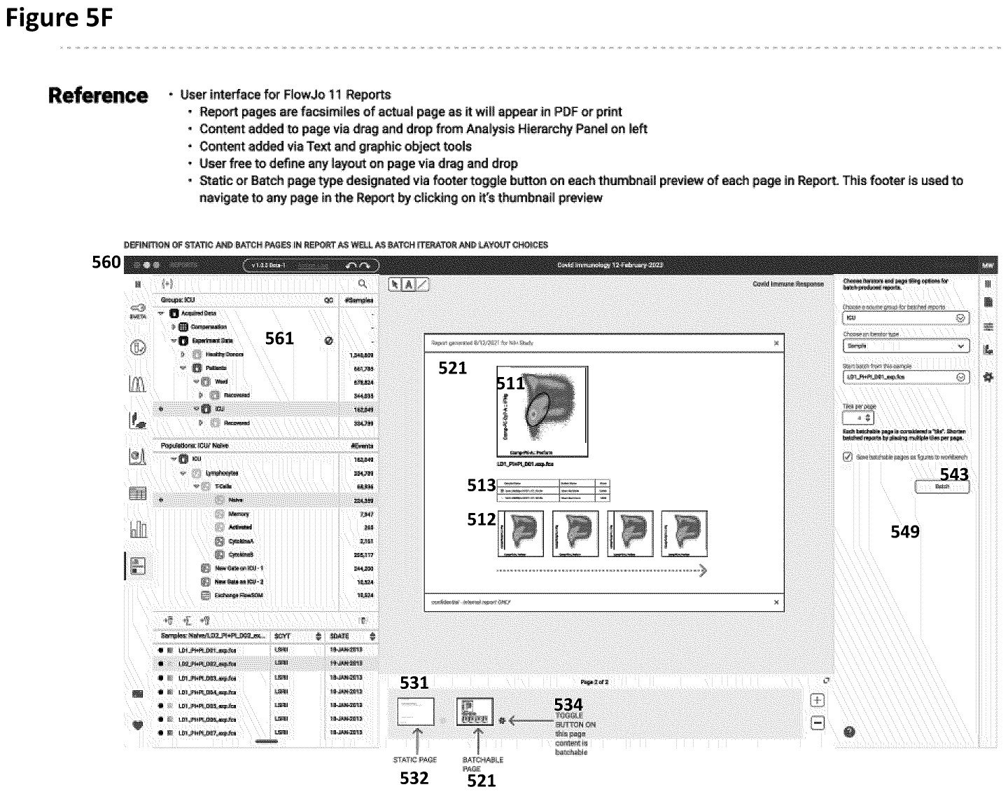

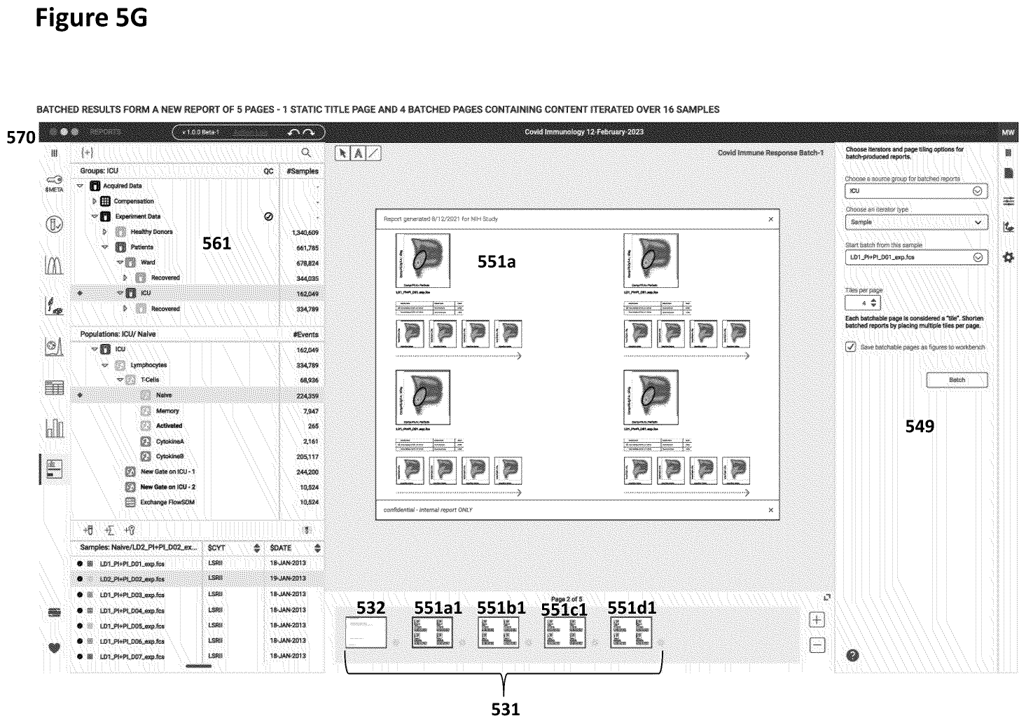

At step 360, the batch report instantiated at step 350 is populated with data from a data set. That is, fields available in the batch report instantiated at step 350 that are capable of receiving data corresponding to the selected iterator type are populated with data from the applicable data set. (For example, batch reports 551a,b,c,d of report 531 shown in FIG. 5, described below, are each populated with data from a data set. Specifically, data corresponding to each axis of plot 511 of report template 521 are populated with data from each data set, where each data set corresponds to a sample (i.e., where the iterator type is specified as sample)).

Upon completion of instantiating a new batch report at step 350, flow diagram 300 next returns to step 340.

As described above, at step 340, when it is determined that each data set of the source group has been processed, such that there are no remaining, unprocessed data sets of the source group, flow diagram 300 next moves to step 370.

At step 370, each batch report generated by application of steps 350 and 360 is displayed. Any convenient display may be used, such as a display on an output device comprising a screen or a monitor or the like. In other instances, at step 370, the plurality of batch reports may be stored to a file capable of being viewed by a user using available software, such as a portable document format (PDF) file or the like.

Upon completion of displaying each batch report at step 370, flow diagram 300 next moves to step 380, where flow diagram 300 ends.

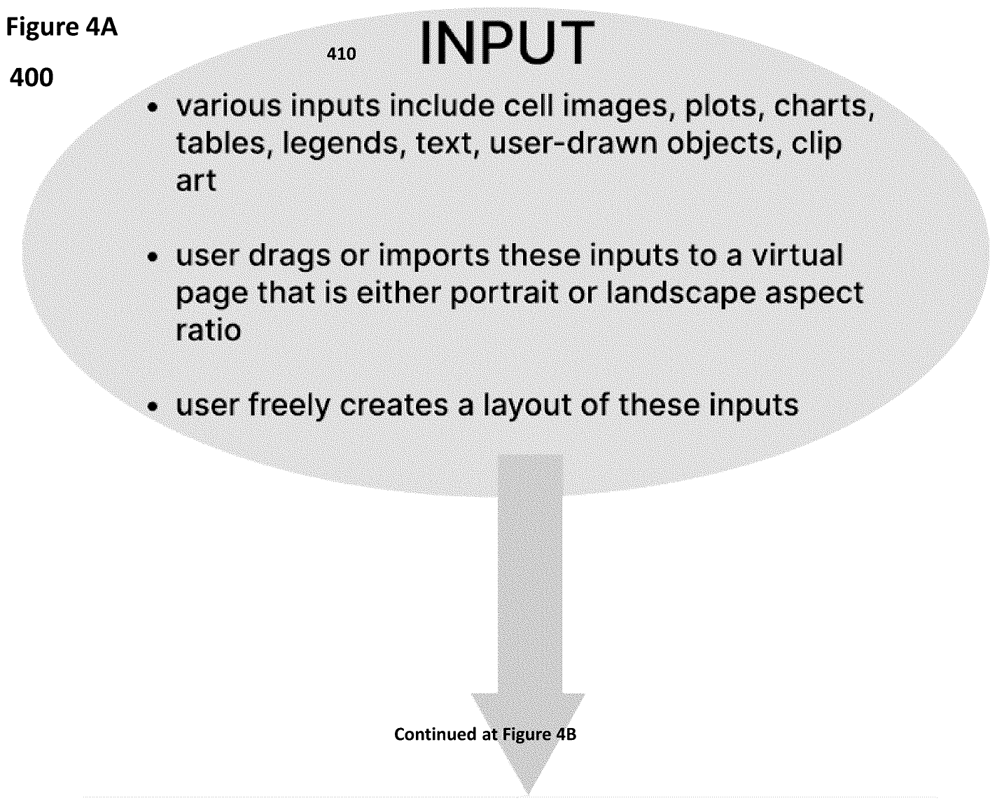

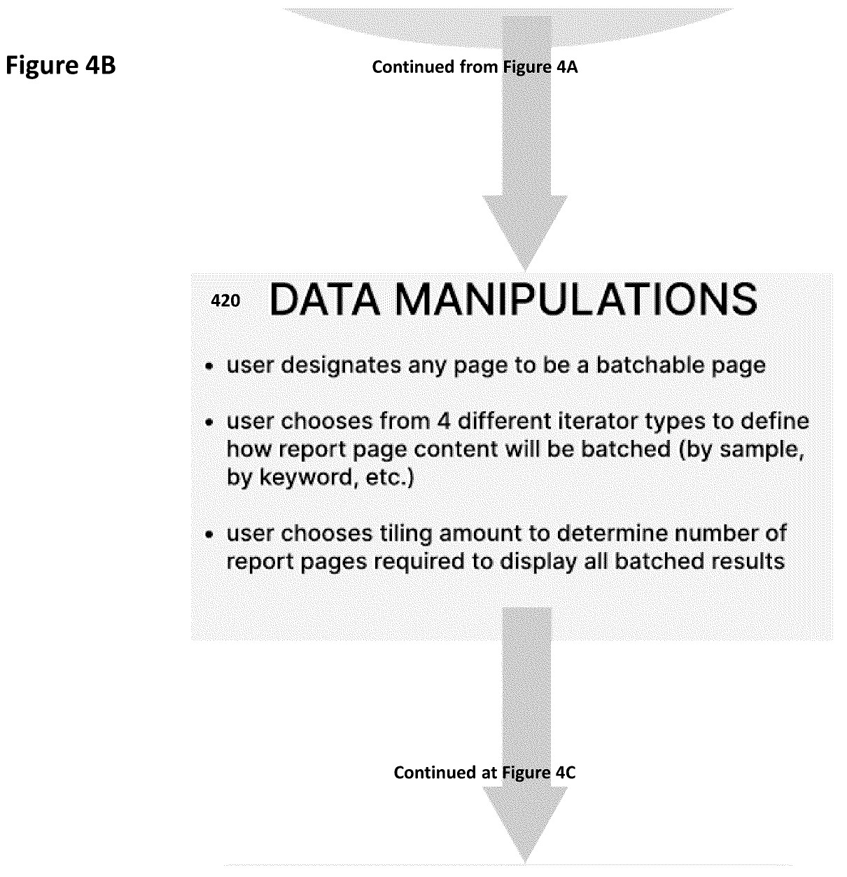

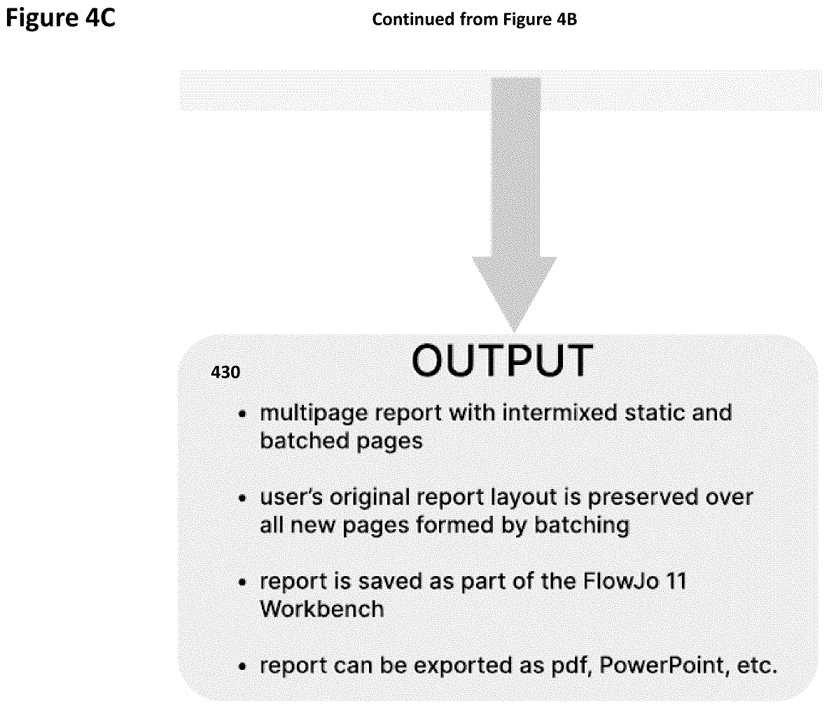

FIGS. 4A-C illustrate flow diagram 400 of a method for automatically generating reports according to another embodiment of the present invention. Flow diagram 400 is an exemplary embodiment of the present invention provided for illustrative purposes. Flow diagram 400 is explained in terms of automatically generating reports related to flow cytometric data collected across a plurality of samples. Any convenient flow cytometric data, such as, for example, light scattering data or fluorescent marker data, related to any convenient samples, that are capable of being presented on a report, may be used to automatically generate reports by applying embodiments of the present invention, and such may vary. However, embodiments of the present invention are not so limited and may be used for automatically generating reports for collections of data sets other than flow cytometric data and/or other than flow cytometric data related to a plurality of different samples, as well.

Flow diagram 400 begins at step 410 seen in FIG. 4A. At step 410, input is collected from a user, where such input ultimately is used to specify aspects of the automatically generated reports. At step 410, a report template is specified by a user. Report templates of interest, in particular report templates for use displaying flow cytometric data, may include cell images, plots, charts, tables, legends, text, user-drawn objects, clip art or any other convenient data visualization structure suitable for presenting flow cytometric data. A user may specify such characteristics and aspects of a report template using any convenient user interface. For example, the user may drag or import various data visualization structures described above to a virtual page, i.e., a page presenting a report template (as opposed to a presentation page, as described herein, displaying one or more batch reports, i.e., reports that have been populated with data). Any convenient format or structure or arrangement or style or layout may be applied to generate a report template, and such may vary according to the user's preferences as well as the nature of the underlying data to be presented in automatically generated reports. In some cases, the user can arrange static content intermixed with batchable content (i.e., content for use automatically generating reports). That is the user can arrange content that is used in connection with automatically generating reports according to embodiments of the present invention, as well as content that remains fixed or static or unchanged as reports are automatically generated. Static content may be present on a separate presentation page or may be present on a presentation page that also comprises batchable content.

Upon completion of step 410, flow diagram 400 next moves to step 420 shown in FIG. 4B.

At step 420, further manipulation and configuration of data associated with the report template occur. For example, the user may designate any presentation page as a batchable page, meaning reports will be automatically generated based on a report template present on such page. The user further specifies an iterator type to define how content will be automatically populated into each report template of a batchable page. Iterator types of interest are described above and include, for example, iterating by sample or by keyword. In addition, at step 420, the user specifies a tiling amount. By tiling amount, it is meant that the user specifies the number of automatically generated reports that can be presented on one presentation page. Therefore, the total number of pages of a presentation used to present automatically generated reports is equal to the number of data sets of the source group divided by the tiling amount.

Upon completion of step 420, flow diagram 400 next moves to step 430 shown in FIG. 4C.

At step 430, a plurality of batch reports is automatically generated based on the report template configured at step 410 and the inputs received at step 420. The batch reports may be intermixed with static pages or static content (i.e., presentation pages, or other content included in or around a report template, that, in each case, were not automatically generated). Any convenient arrangement may be specified or created by the user. Each batch report that is automatically generated at step 430 is based on the structure of the report template specified at step 410. That is, the layout of the report is preserved over each automatically generated report and presentation page. The report may be saved to a computer file on any convenient non-transitory computer-readable storage medium. In certain embodiments, the user may save the presentation pages with automatically generated reports using FlowJo™ software from Becton, Dickinson and Company, such as saving the automatically generated reports to a Workbench aspect of FlowJo™ 11 software from Becton, Dickinson and Company. In embodiments, the user may export the presentation pages with automatically generated reports in another file format, such as a portable document format (PDF) file or a Microsoft PowerPoint file or the like.

Upon completion of step 430, flow diagram 400 ends.

FIGS. 5A-G illustrate flow diagram 500 of a method for automatically generating reports according to another embodiment of the present invention. Flow diagram 500 is an exemplary embodiment of the present invention provided for illustrative purposes. Flow diagram 500 is explained in terms of automatically generating reports related to flow cytometric data collected across a plurality of samples. Any convenient flow cytometric data, such as, for example, light scattering data or fluorescent marker data, related to any convenient samples, that are capable of being presented on a report, may be used to automatically generate reports by applying embodiments of the present invention, and such may vary. However, embodiments of the present invention are not so limited and may be used for automatically generating reports for collections of data sets other than flow cytometric data and/or other than flow cytometric data related to a plurality of different samples, as well.

The embodiment illustrated in FIGS. 5A-G is used to present data from a study related to Covid immune response. In such study, 16 different samples have been analyzed using a flow cytometer and resulting data has been collected. The embodiment illustrated in FIGS. 5A-G is used to generate automatic reports presenting aspects of such data in a manner that individually presents 16 reports associated with each of the 16 samples.

Flow diagram 500 begins at step 510. At step 510, a user provides inputs specifying aspects of report template 521. Such aspects specified, i.e., input by, the user comprise exemplary plot 511 that provides a structure for the presentation of data in automatically generated reports. Specifically, plot 511 is configured by the user to show specific aspects of flow cytometric data collected in connection with this experiment along the x- and y-axes. In addition, the user specifies an arrangement of plots 512. These 4 plots 512 represent iterated content from one specific sample, for example an ‘iterate by parameter’ or ‘iterate by population’ selecting sub-populations of the primary sample.

While plots, such as plot 511, are used in connection with generating report template 521, in other cases, a user may provide other inputs to generate a report template such as one or more of cell images, plots, charts, tables, legends, text, user-drawn objects, clip art or any other convenient data visualization structure suitable for presenting flow cytometric data.

In addition to plot 511 and arrangement 512, the user may specify legend 513 that includes explanatory information about automatically generated plots. In particular legend 513 presents information regarding the samples that were separately analyzed using flow cytometric techniques, the results of which analysis comprise a plurality of data sets of a source group.

Upon completion of step 510, flow diagram 500 next moves to step 520 shown in FIG. 5B.

At step 520, data input at step 510 is manipulated by the user to generate report template 521. In particular, plot 511 and arrangement 512 input by the user at step 510 are arranged and input onto report template 521. Report template 521 comprises an arrangement, input by the user, of plot 511, arrangement of plots 512 and legend 513, in each case, as input at step 510. As a result of arranging or placing or organizing such elements, along with any other desired text, graphics, etc. that may be desired in a final presentation that includes automatically generated reports, report template 521 is generated. The user may arrange or place or organize such aspects of report template 521 using any convenient techniques, such as via a user interface that allows drag and drop manipulations of visual aspects of report template 521. In embodiments, aspects of report template 521 can originate from other reports of other external sources.

Upon completion of step 520, flow diagram 500 next moves to step 530 shown in FIG. 5C.

At step 530, data is further input or manipulated by the user to designate aspects of a presentation (such as report template 521) batchable or static. Report template 521, generated at steps 510 and 520, comprises a part of presentation 531. At step 530, report template 521 is designated by the user as a batchable page. As described above, a batchable page comprises a template, such as report template 521, that is used to guide the automatic generation of batch reports, as described above. That is, all content on a batchable page will be generated over as many additional presentation pages as needed based on the selected iterator type and number of tiles per page and the underlying data sets of the source group. Report template 521 is designated by the user as a batchable page by selecting toggle button 534 to indicate that report template 521 is batchable.

Presentation 531 further comprises static page 532. As described above, static pages, such as static page 532, are not modified or otherwise manipulated in connection with automatically generating reports. Static page 532, for example, comprises a title page for presentation 531, i.e., providing information that is relevant to all automatically generated reports, in contrast to information specific to each report. Static page 532 is designated by the user as a static page by not selecting a corresponding toggle button to indicate that static page 532 is static, not batchable. Presentations according to embodiments of the presentation inventions, such as presentation 531, can comprise multiple intermixed static and batchable pages.

Upon completion of step 530, flow diagram 500 next moves to step 540 shown in FIG. 5D.

At step 540, data is further input by the user to designate parameters for automatically generating reports. Specifically, the user interacts with interface 549, which comprises one aspect of a user interface. Interacting with interface 549, the user selects a source group and iterator type 541 for defining how reports are automatically generated. Source group and iterator type are selected 541, in each case, from drop-down menus of interface 549. In the embodiment shown, the source group comprises samples to be iterated over in connection with automatically generating reports. Also in the embodiment shown, the iterator type is specified to be sample. The user further specifies the number of tiles per page 542 from a separate aspect of interface 549. As described above, selecting a number of tiles per page constrains the number of pages required to display the batched results. In the example depicted in FIGS. 5A-G, 16 samples are available, so selecting four tiles per page means that four report pages will automatically be generated, with four batched, i.e., automatically generated, reports per page. Finally, when the information described above is input as desired by the user, the user initiates automatic generation of reports by clicking on a “Batch” button 543.

Upon completion of step 540, flow diagram 500 next moves to step 550 shown in FIG. 5E.

At step 550, automatically generated reports 551a-d of presentation 531 are output for display to the user. Upon automatically generating reports, presentation 531 comprises static page 532 as well as four automatically generated pages of reports 551a-d. Each of automatically generated pages of reports 551a-d present four plots, each of which corresponds to one of the 16 samples about which flow cytometric data were collected in connection with this experiment. That is, each automatically generated page of reports 551a-d includes data populated from each sample of 16 samples specified in the source group at step 540. That is, each of pages 551a-d contain iterated content from the 16 samples of the source group.

Upon completion of step 550, flow diagram 500 ends 599.

Additional reference information in connection with flow diagram 500 is presented in FIGS. 5F-G. FIG. 5F shows an example user interface 560 displaying components for generating and configuring report template 521 of presentation 531 prior to the user clicking on the “Batch” button 543 to automatically generate batch reports. In FIG. 5F, report template 521 of presentation 531 is presented in the context of a collection of menu options 561 as well as interface 549. In FIG. 5F, it is shown how a user might interact with menu options 561, interface 549, static/batch toggle button 534 to configure report template 521 of presentation 531. As seen in FIGS. 5F-G, automatically generated pages of presentation 531 are based on report template 521. Further, report template 521, and characteristics thereof, is added or otherwise manipulated through a user interface, such as that seen in FIGS. 5F-G, including by manipulating menu options 561. In any event, the user is free to design and configure report template 521 in any convenient way that allows relevant information from each data set of the source group to be presented. Multiple pages of presentation 531 can be added, configured or otherwise manipulated by clicking on page representations 532, 521, for example.

FIG. 5G shows an example user interface 570 displaying components for configuring and manipulating presentation 531 and aspects of batched reports 551a, 551a1,b1,c1,d1 thereof after batch reports were automatically generated upon the user clicking on the “Batch” button 543. As a result of the user clicking on the “Batch” button 543 to automatically generate batch reports, presentation 531 has been expanded to included batched report pages 551a1, 551b1, 551c1, 551d1, in addition to static page 532, which remains unchanged after automatic reports were generated. As described above in connection with step 550 of FIG. 5E, since there are 16 samples and the number of tiles per page is set to four, four batched report pages are automatically generated. User interface 570 includes, near the bottom, thumbnails of presentation 531 pages 532, 551a1, 551b1, 551c1, 551d1 such that clicking on one of the thumbnail images brings up a larger version of such page 551a that corresponds to the thumbnail page 551a1. In FIG. 5G, thumbnail of report page 551a1 has been clicked on and, as a result, is shown as enlarged batched report 551a.

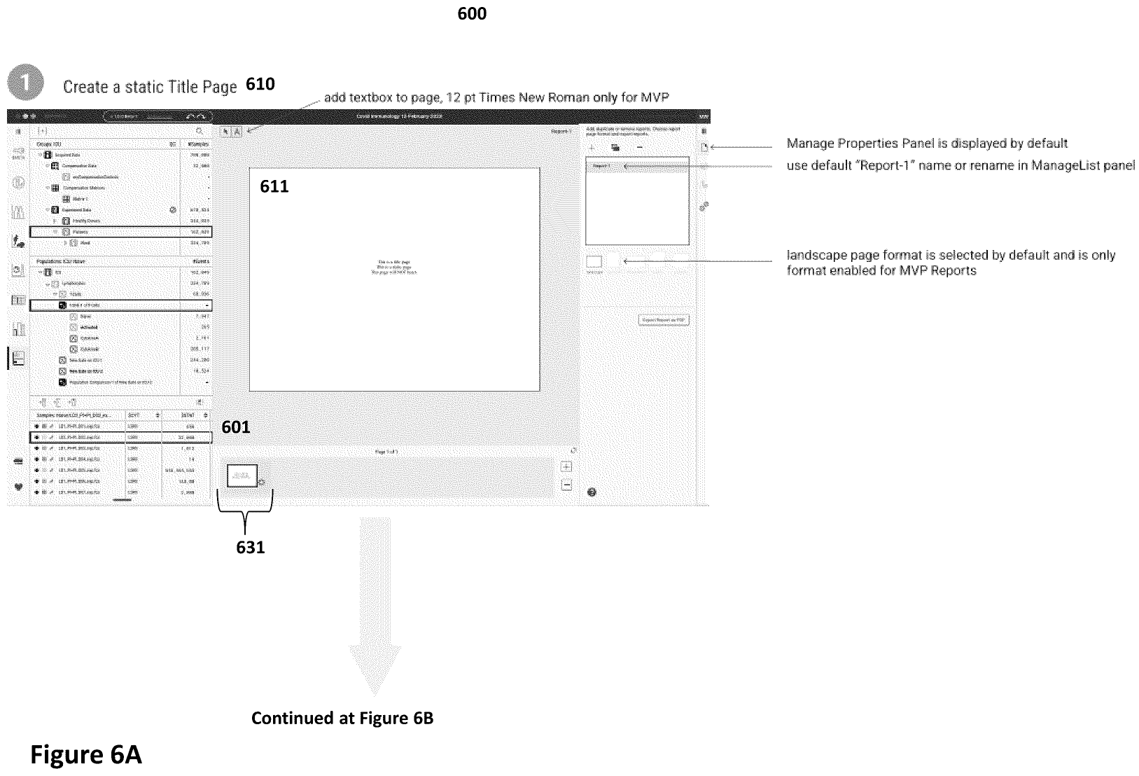

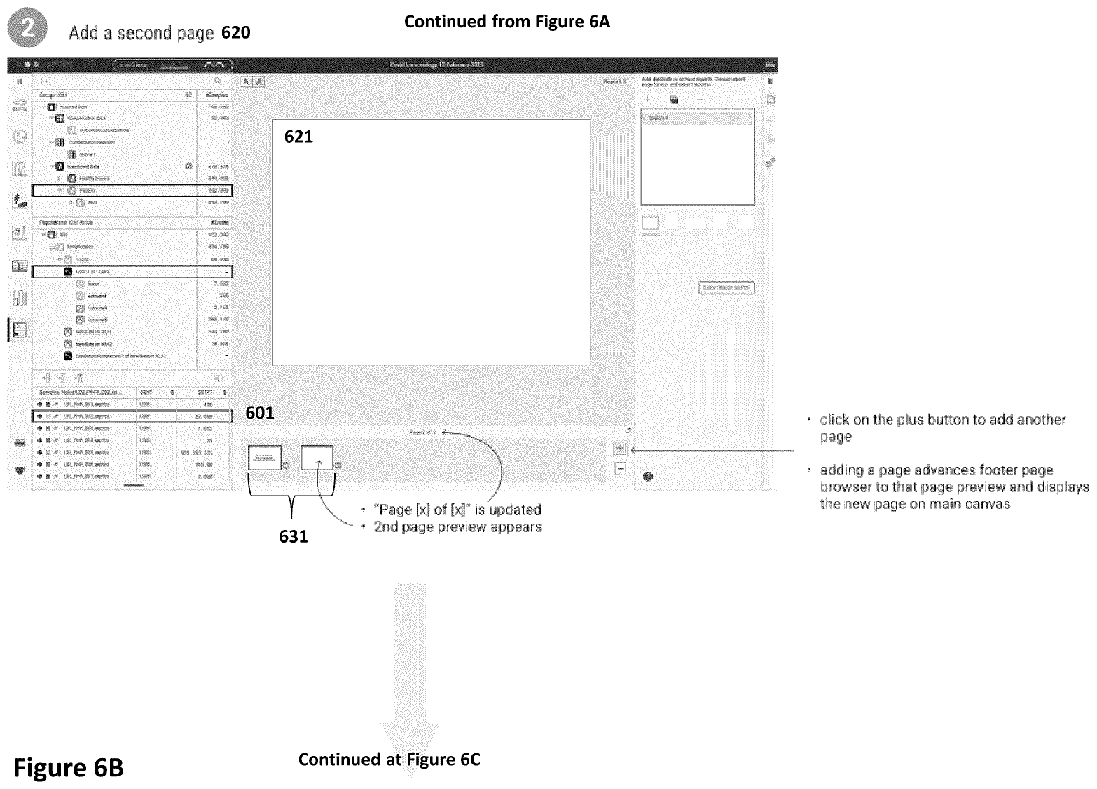

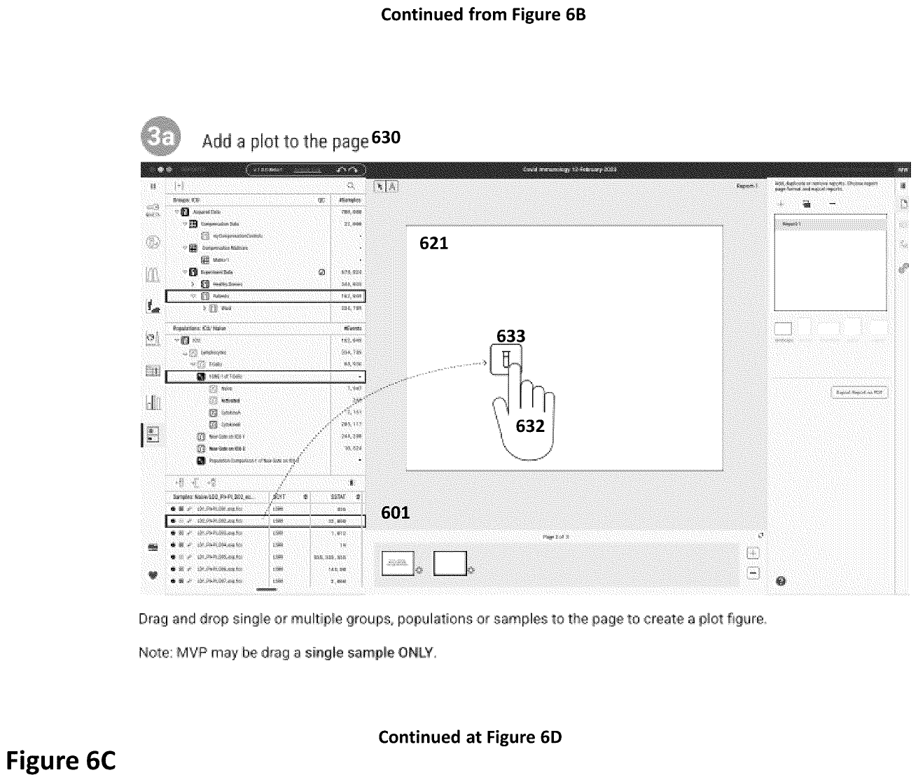

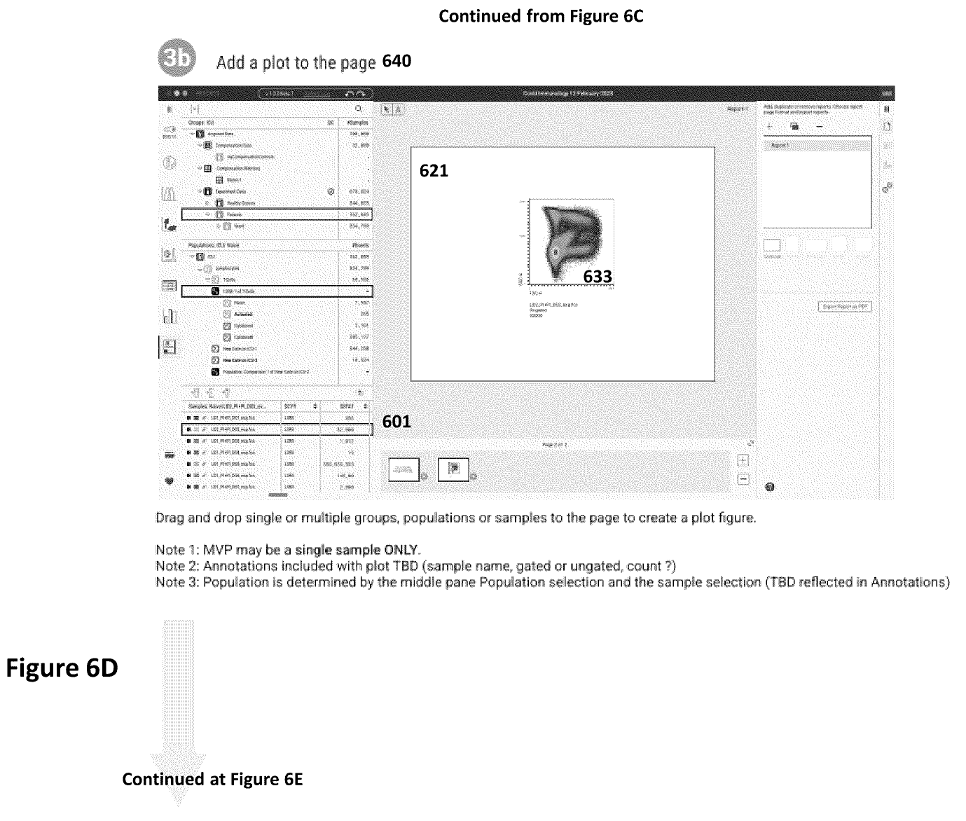

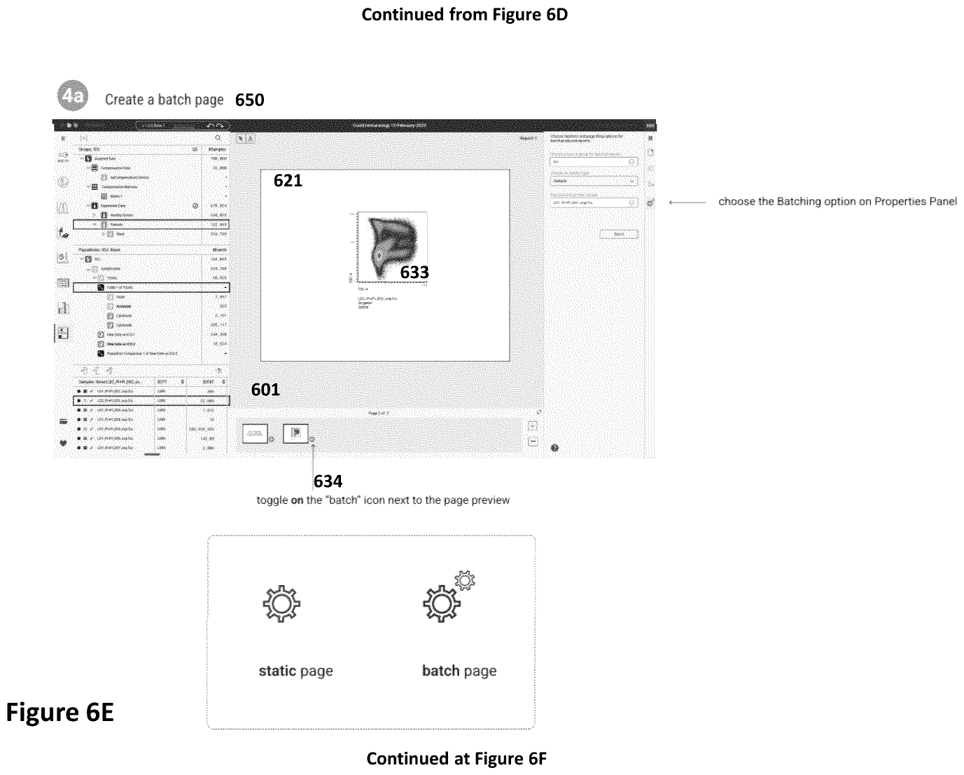

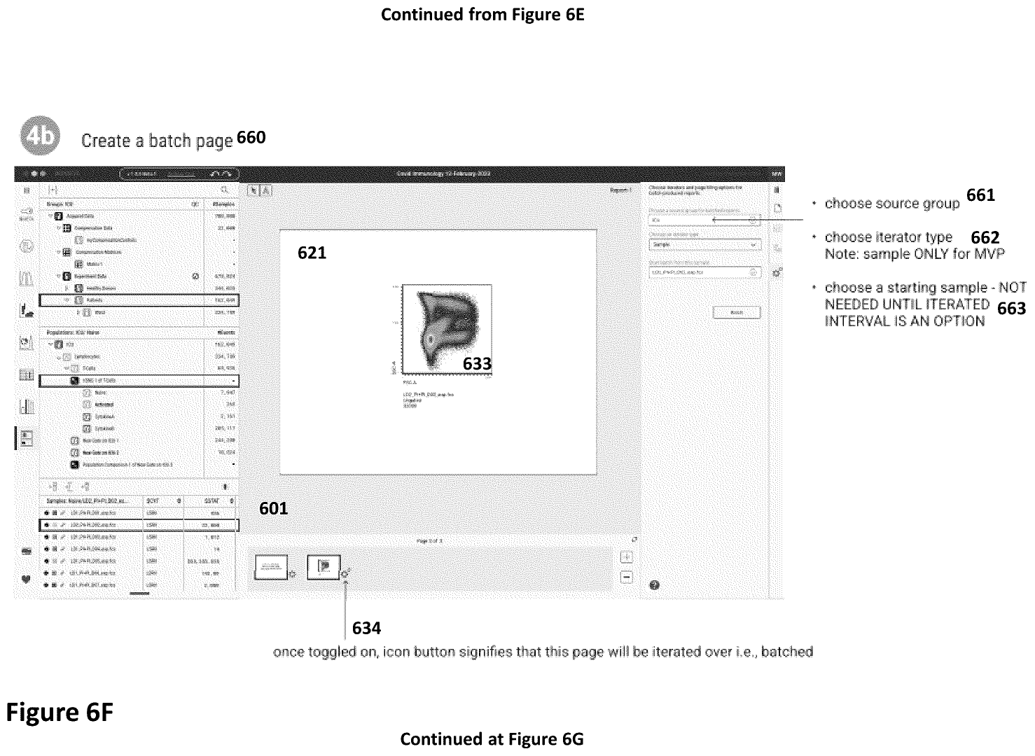

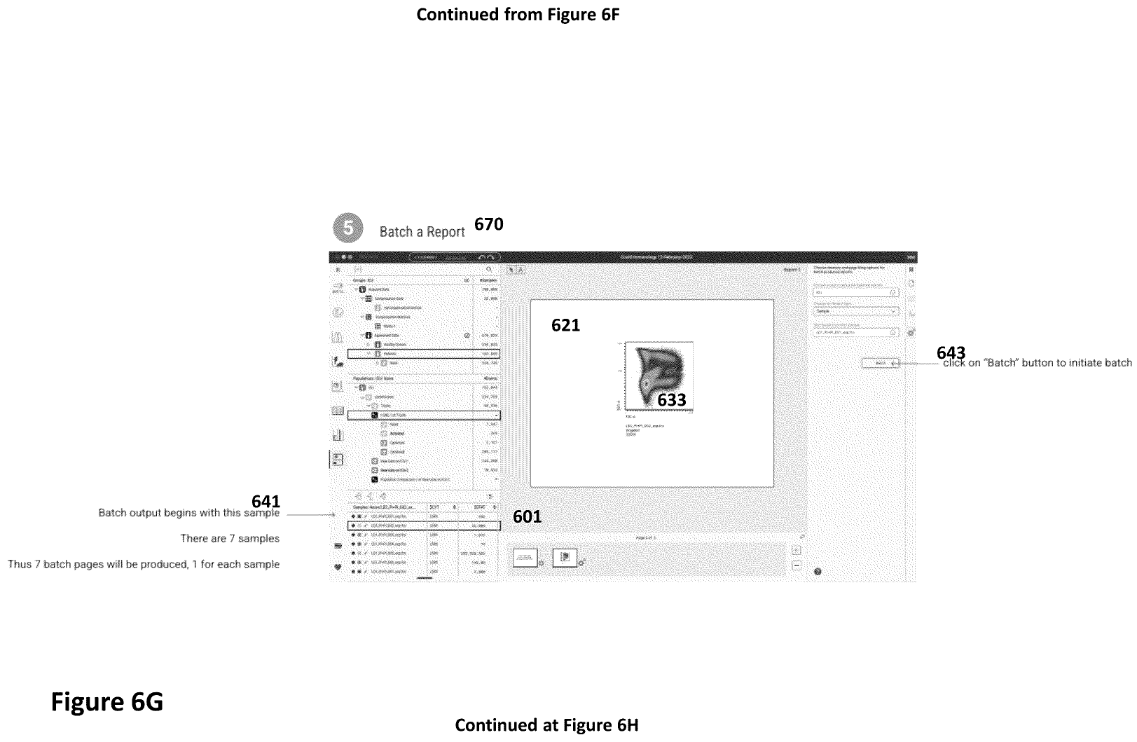

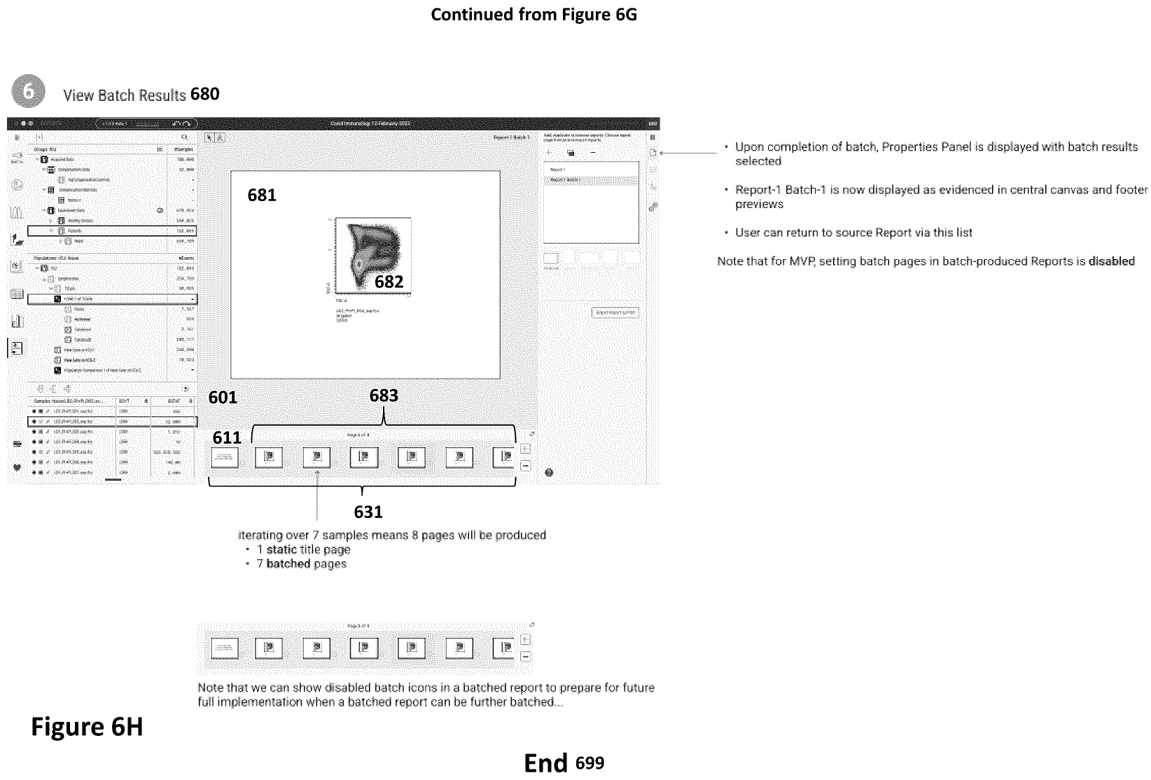

FIGS. 6A-H illustrate flow diagram 600 of a method for automatically generating reports according to still another embodiment of the present invention. Flow diagram 600 is an exemplary embodiment of the present invention provided for illustrative purposes. Flow diagram 600 is explained in terms of automatically generating reports related to flow cytometric data collected across a plurality of samples. Any convenient flow cytometric data, such as, for example, light scattering data or fluorescent marker data, related to any convenient samples, that are capable of being presented on a report may be used to automatically generate reports by applying embodiments of the present invention, and such may vary. However, embodiments of the present invention are not so limited and may be used for automatically generating reports for collections of data sets other than flow cytometric data and/or other than flow cytometric data related to a plurality of different samples, as well.

FIGS. 6A-H illustrate flow diagram 600 by showing the state of interface 601 during the various steps of flow diagram 600. That is, FIGS. 6A-H show interface 601 from a user's perspective over the course of applying flow diagram 600 to automatically generate batch reports.

Flow diagram 600 begins at step 610 shown in FIG. 6A. At step 610, the user interacts with interface 601 to create and configure static title page 611 of presentation 631. Specifically, the user interacts with aspects of interface 601 to add a textbox to static page 611; to configure static page 611 to be in landscape mode; as well as to name presentation 631, which presentation 631 ultimately will include automatically generated batch reports in connection with applying flow diagram 600.

Upon completion of creating a static page at step 610 shown in FIG. 6A, flow diagram 600 next moves to step 620 shown at FIG. 6B.

At step 620 shown in FIG. 6B, the user interacts with interface 601 to add second page 621 to presentation 631. Second page 621 follows first page 611 of presentation 631. At step 620, second page 621 is completely blank.

Upon completion of adding a second page at step 620 shown in FIG. 6B, flow diagram 600 next moves to step 630 shown at FIG. 6C.

At step 630 shown in FIG. 6C, the user interacts with interface 601 to add plot 633 to second page 621 of presentation 631. Plot 633 is added to second page 621 by dragging and dropping 632 it from a part of interface 601 onto second page 621. In the figure, MVP stands for minimum variable product.

Upon completion of adding a plot at step 630 shown in FIG. 6C, flow diagram 600 next moves to step 640 shown at FIG. 6D.

At step 640 shown in FIG. 6D, the user interacts with interface 601 to further configure plot 633 by specifying whether plot 633 is associated with single or multiple groups, populations or samples of data. In the case of plot 633, the user specifies that plot 633 is associated with a single sample only and may include annotations, including, for example, a sample name, whether the data is gated or ungated as well as count information (i.e., count of events detected by a flow cytometer that are displayed in plot 633).

Upon completion of configuring plot 633 at step 640 shown in FIG. 6D, flow diagram 600 next moves to step 650 shown in FIG. 6E.

At step 650 shown in FIG. 6E, the user interacts with interface 601 to specify that second page 621, including plot 633 thereof, is batchable. That is, by selecting the batch option on batch toggle icon 634, the user specifies that second page 621, with plot 633, is to be treated as a report template. That is, application of flow diagram 600 will automatically generate batched reports that are instances of second page 621 with plot 633 (together, a report template).

Upon completion of specifying that second page 621, including plot 633 thereof, is batchable at step 650 shown in FIG. 6E, flow diagram 600 next moves to step 660 shown in FIG. 6F.

At step 660 shown in FIG. 6F, the user interacts with interface 601 to configure aspects of batchable second page 621 (i.e., report template). In particular, the user interacts with parts of interface 601 to choose a source group 661 (i.e., data for use in populating each batch report); to choose an iterator type 662 (in the example shown at selection 662, the iterator type is set to iterate by sample only); and to choose a starting sample 663 (i.e., which sample is first used to automatically populate a batch report).

Upon completion of configuring aspects of batchable second page 621 (i.e., report template) at step 660 shown in FIG. 6F, flow diagram 600 next moves to step 670 shown in FIG. 6G.

At step 670 shown in FIG. 6G, batching reports (i.e., automatically generating batched reports) is initiated. In order to initiate the process of generating batched reports, the user clicks on the “Batch” button 643. As described above, iterator type 662 is set to iterate by sample. As a result, automatically generated reports are generated that are batched by sample. In the example shown, there are seven different samples 641 available, with the current sample highlighted in the list of samples 641.

Upon completion of initiating automatically generating batched reports at step 670 shown in FIG. 6G, flow diagram 600 next moves to step 680 shown in FIG. 6H. At step 680 shown in FIG. 6H, batched reports 683 (i.e., automatically generated reports) of presentation 631 are displayed on interface 601. Interface 601 further displays a blown-up version of one of the automatically generated reports 683 for further inspection and manipulation or configuration by the user, as desired. Since, in the example depicted, seven samples were used, the resulting presentation 631 comprises seven automatically generated report pages 683 as well as a single static page 611.

Upon completion of displaying batched reports 683 (i.e., automatically generated reports) of presentation 631 at step 680 shown in FIG. 6H, flow diagram 600 ends 699.

### Obtaining Flow Cytometry Data:

As described above, embodiments of the present invention may be applied to data collected using a flow cytometer, e.g., any convenient flow cytometer, such as those described herein. In some embodiments, data for presentation on automatically generated (i.e., batched) reports generated using embodiments of the present invention may comprise light scatter data from particles of a sample collected by flow cytometrically analyzing such particles (i.e., traditional flow cytometry). In addition, in some cases, data for presentation on batched reports generated using embodiments of the present invention may comprise imaging data collected using any convenient imaging technique, such as an imaging flow cytometer. Techniques for collecting such light scattering data and/or imaging data, e.g., by application of a flow cytometer, are described further below.

### Flow Cytometry:

A flow cytometer typically includes a sample reservoir for receiving a fluid sample, such as a sample including particles, e.g., cells, for classification or analysis, and a sheath reservoir containing a sheath fluid. The flow cytometer transports the particles (including cells, e.g., from the sample) in the fluid sample as a cell stream to a flow cell, while also directing the sheath fluid to the flow cell. To characterize the components of the flow stream, the flow stream is irradiated with light. Variations in the materials in the flow stream, such as morphologies or the presence of fluorescent labels, may cause variations in the observed light and these variations allow for characterization and, in some cases, separation. For example, particles, such as molecules, analyte-bound beads, or individual cells, in a fluid suspension are passed by a detection region in which the particles are exposed to an excitation light, typically from one or more lasers, and the light scattering and fluorescence properties of the particles are measured. Particles or components thereof typically are labeled with fluorescent dyes to facilitate detection. A multiplicity of different particles or components may be simultaneously detected by using spectrally distinct fluorescent dyes to label the different particles or components. In some implementations, a multiplicity of detectors, one for each of the scatter parameters to be measured, and one or more for each of the distinct dyes to be detected are included in the analyzer. For example, some embodiments include spectral configurations where more than one sensor or detector is used per dye. The data obtained include the signals measured for each of the light scatter detectors and the fluorescence emissions. In certain embodiments, the flow cytometric assay may detect a signal indicating the presence of the labeled secondary antibody in the sample.

### Light Source:

As summarized above, a sample (e.g., in a flow stream of the flow cytometer) may be irradiated with light from a light source. In some embodiments, the light source is a broadband light source, emitting light having a broad range of wavelengths, such as for example, spanning 50 nm or more, such as 100 nm or more, such as 150 nm or more, such as 200 nm or more, such as 250 nm or more, such as 300 nm or more, such as 350 nm or more, such as 400 nm or more and including spanning 500 nm or more. For example, one suitable broadband light source emits light having wavelengths from 200 nm to 1500 nm. Another example of a suitable broadband light source includes a light source that emits light having wavelengths from 400 nm to 1000 nm. Where methods include irradiating with a broadband light source, broadband light source protocols of interest may include, but are not limited to, a halogen lamp, deuterium arc lamp, xenon arc lamp, stabilized fiber-coupled broadband light source, a broadband LED with continuous spectrum, super luminescent emitting diode, semiconductor light emitting diode, wide spectrum LED white light source, an multi-LED integrated white light source, among other broadband light sources or any combination thereof.

In other embodiments, methods includes irradiating with a narrow band light source emitting a particular wavelength or a narrow range of wavelengths, such as for example with a light source which emits light in a narrow range of wavelengths like a range of 50 nm or less, such as 40 nm or less, such as 30 nm or less, such as 25 nm or less, such as 20 nm or less, such as 15 nm or less, such as 10 nm or less, such as 5 nm or less, such as 2 nm or less and including light sources which emit a specific wavelength of light (i.e., monochromatic light). Where methods include irradiating with a narrow band light source, narrow band light source protocols of interest may include, but are not limited to, a narrow wavelength LED, laser diode or a broadband light source coupled to one or more optical bandpass filters, diffraction gratings, monochromators or any combination thereof.

In certain embodiments, methods include irradiating the sample with one or more lasers. As discussed above, the type and number of lasers will vary depending on the sample as well as desired light collected and may be a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof. In other instances, the methods include irradiating the flow stream with a dye laser, such as a stilbene, coumarin or rhodamine laser. In yet other instances, methods include irradiating the flow stream with a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof. In still other instances, methods include irradiating the flow stream with a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulium YAG laser, ytterbium YAG laser, ytterbium₂O₃ laser or cerium doped lasers and combinations thereof.

The sample may be irradiated with one or more of the above-mentioned light sources, such as two or more light sources, such as three or more light sources, such as four or more light sources, such as five or more light sources and including ten or more light sources. The light source may include any combination of types of light sources. For example, in some embodiments, the methods include irradiating the sample in the flow stream with an array of lasers, such as an array having one or more gas lasers, one or more dye lasers and one or more solid-state lasers.

The sample may be irradiated with wavelengths ranging from 200 nm to 1500 nm, such as from 250 nm to 1250 nm, such as from 300 nm to 1000 nm, such as from 350 nm to 900 nm and including from 400 nm to 800 nm. For example, where the light source is a broadband light source, the sample may be irradiated with wavelengths from 200 nm to 900 nm. In other instances, where the light source includes a plurality of narrow band light sources, the sample may be irradiated with specific wavelengths in the range from 200 nm to 900 nm. For example, the light source may be a plurality of narrow band LEDs (1 nm-25 nm) each independently emitting light having a range of wavelengths between 200 nm to 900 nm. In other embodiments, the narrow band light source includes one or more lasers (such as a laser array) and the sample is irradiated with specific wavelengths ranging from 200 nm to 700 nm, such as with a laser array having gas lasers, excimer lasers, dye lasers, metal vapor lasers and solid-state laser as described above.

Where more than one light source is employed, the sample may be irradiated with the light sources simultaneously or sequentially, or a combination thereof. For example, the sample may be simultaneously irradiated with each of the light sources. In other embodiments, the flow stream is sequentially irradiated with each of the light sources. Where more than one light source is employed to irradiate the sample sequentially, the time each light source irradiates the sample may independently be 0.001 microseconds or more, such as 0.01 microseconds or more, such as 0.1 microseconds or more, such as 1 microsecond or more, such as 5 microseconds or more, such as 10 microseconds or more, such as 30 microseconds or more and including 60 microseconds or more. For example, methods may include irradiating the sample with the light source (e.g., laser) for a duration which ranges from 0.001 microseconds to 100 microseconds, such as from 0.01 microseconds to 75 microseconds, such as from 0.1 microseconds to 50 microseconds, such as from 1 microsecond to 25 microseconds and including from 5 microseconds to 10 microseconds. In embodiments where the sample is sequentially irradiated with two or more light sources, the duration the sample is irradiated by each light source may be the same or different.

The time period between irradiation by each light source may also vary, as desired, being separated independently by a delay of 0.001 microseconds or more, such as 0.01 microseconds or more, such as 0.1 microseconds or more, such as 1 microsecond or more, such as 5 microseconds or more, such as by 10 microseconds or more, such as by 15 microseconds or more, such as by 30 microseconds or more and including by 60 microseconds or more. For example, the time period between irradiation by each light source may range from 0.001 microseconds to 60 microseconds, such as from 0.01 microseconds to 50 microseconds, such as from 0.1 microseconds to 35 microseconds, such as from 1 microsecond to 25 microseconds and including from 5 microseconds to 10 microseconds. In certain embodiments, the time period between irradiation by each light source is 10 microseconds. In embodiments where sample is sequentially irradiated by more than two (i.e., three or more) light sources, the delay between irradiation by each light source may be the same or different.

The sample may be irradiated continuously or in discrete intervals. In some instances, methods include irradiating the sample with the light source continuously. In other instances, the sample is irradiated with the light source in discrete intervals, such as irradiating every 0.001 millisecond, every 0.01 millisecond, every 0.1 millisecond, every 1 millisecond, every 10 milliseconds, every 100 milliseconds and including every 1000 milliseconds, or some other interval.

Depending on the light source, the sample may be irradiated from a distance which varies such as 0.01 mm or more, such as 0.05 mm or more, such as 0.1 mm or more, such as 0.5 mm or more, such as 1 mm or more, such as 2.5 mm or more, such as 5 mm or more, such as 10 mm or more, such as 15 mm or more, such as 25 mm or more and including 50 mm or more. Also, the angle or irradiation may also vary, ranging from 10° to 90°, such as from 15° to 85°, such as from 20° to 80°, such as from 25° to 75° and including from 30° to 60°, for example at a 90° angle.

In certain embodiments, methods include irradiating the sample with two or more beams of frequency shifted light. A light beam generator component may be employed having a laser and an acousto-optic device for frequency shifting the laser light. In these embodiments, methods include irradiating the acousto-optic device with the laser. Depending on the desired wavelengths of light produced in the output laser beam (e.g., for use in irradiating a sample in a flow stream), the laser may have a specific wavelength that varies from 200 nm to 1,500 nm, such as from 250 nm to 1,250 nm, such as from 300 nm to 1,000 nm, such as from 350 nm to 900 nm and including from 400 nm to 800 nm. The acousto-optic device may be irradiated with one or more lasers, such as two or more lasers, such as three or more lasers, such as four or more lasers, such as five or more lasers and including ten or more lasers. The lasers may include any combination of types of lasers. For example, in some embodiments, the methods include irradiating the acousto-optic device with an array of lasers, such as an array having one or more gas lasers, one or more dye lasers and one or more solid-state lasers.

Where more than one laser is employed, the acousto-optic device may be irradiated with the lasers simultaneously or sequentially, or a combination thereof. For example, the acousto-optic device may be simultaneously irradiated with each of the lasers. In other embodiments, the acousto-optic device is sequentially irradiated with each of the lasers. Where more than one laser is employed to irradiate the acousto-optic device sequentially, the time each laser irradiates the acousto-optic device may independently be 0.001 microseconds or more, such as 0.01 microseconds or more, such as 0.1 microseconds or more, such as 1 microsecond or more, such as 5 microseconds or more, such as 10 microseconds or more, such as 30 microseconds or more and including 60 microseconds or more. For example, methods may include irradiating the acousto-optic device with the laser for a duration which ranges from 0.001 microseconds to 100 microseconds, such as from 0.01 microseconds to 75 microseconds, such as from 0.1 microseconds to 50 microseconds, such as from 1 microsecond to 25 microseconds and including from 5 microseconds to 10 microseconds. In embodiments where the acousto-optic device is sequentially irradiated with two or more lasers, the duration the acousto-optic device is irradiated by each laser may be the same or different.

The time period between irradiation by each laser may also vary, as desired, being separated independently by a delay of 0.001 microseconds or more, such as 0.01 microseconds or more, such as 0.1 microseconds or more, such as 1 microsecond or more, such as 5 microseconds or more, such as by 10 microseconds or more, such as by 15 microseconds or more, such as by 30 microseconds or more and including by 60 microseconds or more. For example, the time period between irradiation by each light source may range from 0.001 microseconds to 60 microseconds, such as from 0.01 microseconds to 50 microseconds, such as from 0.1 microseconds to 35 microseconds, such as from 1 microsecond to 25 microseconds and including from 5 microseconds to 10 microseconds. In certain embodiments, the time period between irradiation by each laser is 10 microseconds. In embodiments where the acousto-optic device is sequentially irradiated by more than two (i.e., three or more) lasers, the delay between irradiation by each laser may be the same or different.

The acousto-optic device may be irradiated continuously or in discrete intervals. In some instances, methods include irradiating the acousto-optic device with the laser continuously. In other instances, the acousto-optic device is irradiated with the laser in discrete intervals, such as irradiating every 0.001 millisecond, every 0.01 millisecond, every 0.1 millisecond, every 1 millisecond, every 10 milliseconds, every 100 milliseconds and including every 1,000 milliseconds, or some other interval.

Depending on the laser, the acousto-optic device may be irradiated from a distance which varies such as 0.01 mm or more, such as 0.05 mm or more, such as 0.1 mm or more, such as 0.5 mm or more, such as 1 mm or more, such as 2.5 mm or more, such as 5 mm or more, such as 10 mm or more, such as 15 mm or more, such as 25 mm or more and including 50 mm or more. Also, the angle or irradiation may also vary, ranging from 10° to 90°, such as from 15° to 85°, such as from 20° to 80°, such as from 25° to 75° and including from 30° to 60°, for example at a 90° angle.

In embodiments, methods include applying radiofrequency drive signals to the acousto-optic device to generate angularly deflected laser beams. Two or more radiofrequency drive signals may be applied to the acousto-optic device to generate an output laser beam with the desired number of angularly deflected laser beams, such as three or more radiofrequency drive signals, such as four or more radiofrequency drive signals, such as five or more radiofrequency drive signals, such as six or more radiofrequency drive signals, such as seven or more radiofrequency drive signals, such as eight or more radiofrequency drive signals, such as nine or more radiofrequency drive signals, such as ten or more radiofrequency drive signals, such as 15 or more radiofrequency drive signals, such as 25 or more radiofrequency drive signals, such as 50 or more radiofrequency drive signals and including 100 or more radiofrequency drive signals.

The angularly deflected laser beams produced by the radiofrequency drive signals each have an intensity based on the amplitude of the applied radiofrequency drive signal. In some embodiments, methods include applying radiofrequency drive signals having amplitudes sufficient to produce angularly deflected laser beams with a desired intensity. In some instances, each applied radiofrequency drive signal independently has an amplitude from about 0.001 V to about 500 V, such as from about 0.005 V to about 400 V, such as from about 0.01 V to about 300 V, such as from about 0.05 V to about 200 V, such as from about 0.1 V to about 100 V, such as from about 0.5 V to about 75 V, such as from about 1 V to 50 V, such as from about 2 V to 40 V, such as from 3 V to about 30 V and including from about 5 V to about 25 V. Each applied radiofrequency drive signal has, in some embodiments, a frequency of from about 0.001 MHz to about 500 MHz, such as from about 0.005 MHz to about 400 MHZ, such as from about 0.01 MHz to about 300 MHz, such as from about 0.05 MHz to about 200 MHZ, such as from about 0.1 MHz to about 100 MHz, such as from about 0.5 MHz to about 90 MHz, such as from about 1 MHz to about 75 MHz, such as from about 2 MHz to about 70 MHz, such as from about 3 MHz to about 65 MHz, such as from about 4 MHz to about 60 MHz and including from about 5 MHz to about 50 MHz.

In these embodiments, the angularly deflected laser beams in the output laser beam are spatially separated. Depending on the applied radiofrequency drive signals and desired irradiation profile of the output laser beam, the angularly deflected laser beams may be separated by 0.001 μm or more, such as by 0.005 μm or more, such as by 0.01 μm or more, such as by 0.05 μm or more, such as by 0.1 μm or more, such as by 0.5 μm or more, such as by 1 μm or more, such as by 5 μm or more, such as by 10 μm or more, such as by 100 μm or more, such as by 500 μm or more, such as by 1,000 μm or more and including by 5,000 μm or more. In some embodiments, the angularly deflected laser beams overlap, such as with an adjacent angularly deflected laser beam along a horizontal axis of the output laser beam. The overlap between adjacent angularly deflected laser beams (such as overlap of beam spots) may be an overlap of 0.001 μm or more, such as an overlap of 0.005 μm or more, such as an overlap of 0.01 μm or more, such as an overlap of 0.05 μm or more, such as an overlap of 0.1 μm or more, such as an overlap of 0.5 μm or more, such as an overlap of 1 μm or more, such as an overlap of 5 μm or more, such as an overlap of 10 μm or more and including an overlap of 100 μm or more.

### Light Detectors:

Aspects of the present methods include collecting scattered or fluorescent light with a light detector, such as a fluorescent light detector. A fluorescent light detector may, in some instances, be configured to detect fluorescence emissions from fluorescent molecules, e.g., labeled specific binding members (such as labeled antibodies that specifically bind to markers of interest) associated with the particle in the flow cell. In certain embodiments, methods include detecting fluorescence from the sample with one or more fluorescent light detectors, such as two or more, such as three or more, such as four or more, such as five or more, such as six or more, such as seven or more, such as eight or more, such as nine or more, such as ten or more, such as 15 or more and including 25 or more fluorescent light detectors. In embodiments, each of the fluorescent light detectors is configured to generate a fluorescence data signal. Fluorescence from the sample may be detected by each fluorescent light detector, independently, over one or more of the wavelength ranges of 200 nm to 1,200 nm. In some instances, methods include detecting fluorescence from the sample over a range of wavelengths, such as from 200 nm to 1,200 nm, such as from 300 nm to 1,100 nm, such as from 400 nm to 1,000 nm, such as from 500 nm to 900 nm and including from 600 nm to 800 nm. In other instances, methods include detecting fluorescence with each fluorescence detector at one or more specific wavelengths. For example, the fluorescence may be detected at one or more of 450 nm, 518 nm, 519 nm, 561 nm, 578 nm, 605 nm, 607 nm, 625 nm, 650 nm, 660 nm, 667 nm, 670 nm, 668 nm, 695 nm, 710 nm, 723 nm, 780 nm, 785 nm, 647 nm, 617 nm and any combinations thereof, depending on the number of different fluorescent light detectors in the subject light detection system. In certain embodiments, methods include detecting wavelengths of light which correspond to the fluorescence peak wavelength of certain fluorophores present in the sample. In embodiments, fluorescent flow cytometer data is received from one or more fluorescent light detectors (e.g., one or more detection channels), such as two or more, such as three or more, such as four or more, such as five or more, such as six or more and including eight or more fluorescent light detectors (e.g., eight or more detection channels).

Light from the sample may be measured at one or more wavelengths of, such as at five or more different wavelengths, such as at ten or more different wavelengths, such as at 25 or more different wavelengths, such as at 50 or more different wavelengths, such as at 100 or more different wavelengths, such as at 200 or more different wavelengths, such as at 300 or more different wavelengths and including measuring the collected light at 400 or more different wavelengths.

The collected light may be measured continuously or in discrete intervals. In some instances, methods include taking measurements of the light continuously. In other instances, the light is measured in discrete intervals, such as measuring light every 0.001 millisecond, every 0.01 millisecond, every 0.1 millisecond, every 1 millisecond, every 10 milliseconds, every 100 milliseconds and including every 1,000 milliseconds, or some other interval.

Measurements of the collected light may be taken one or more times during the subject methods, such as 2 or more times, such as 3 or more times, such as 5 or more times and including 10 or more times. In certain embodiments, the light propagation is measured 2 or more times, with the data in certain instances being averaged.

In certain embodiments, methods include spectrally resolving the light from each fluorophore of a fluorophore-biomolecule pair in the sample. In some embodiments, the overlap between each different fluorophore is determined and the contribution of each fluorophore to the overlapping fluorescence is calculated. In some embodiments, spectrally resolving light from each fluorophore includes calculating a spectral unmixing matrix for the fluorescence spectra for each of the plurality of fluorophores having overlapping fluorescence in the sample detected by the light detection system. In certain instances, spectrally resolving the light from each fluorophore and calculating a spectral unmixing matrix for each fluorophore may be used to estimate the abundance of each fluorophore, such as for example to resolve the abundance of target cells in the sample.

In certain embodiments, methods include spectrally resolving light detected by a plurality of photodetectors such as described e.g., U.S. Pat. No. 11,009,400; U.S. Patent Application Publication Nos. 20210247293 and 20210325292; the disclosures of which are herein incorporated by reference in their entirety. For example, spectrally resolving light detected by the plurality of photodetectors of the second set of photodetectors may be include solving a spectral unmixing matrix using one or more of: 1) a weighted least square algorithm; 2) a Sherman-Morrison iterative inverse updater; 3) an LU matrix decomposition, such as where a matrix is decomposed into a product of a lower-triangular (L) matrix and an upper-triangular (U) matrix; 4) a modified Cholesky decomposition; 5) by QR factorization; and 6) calculating a weighted least squares algorithm by singular value decomposition. In certain embodiments, methods further include characterizing the spillover spreading of the light detected by a plurality of photodetectors such as described e.g., in U.S. Patent Application Publication No. 20210349004, the disclosure of which is herein incorporated by reference.

In certain instances, the abundance of fluorophores associated with (e.g., chemically associated (i.e., covalently, ionically) or physically associated) a target particle is calculated from the spectrally resolved light from each fluorophore associated with the particle. For instance, in one example the relative abundance of each fluorophore associated with a target particle is calculated from the spectrally resolved light from each fluorophore. In another example, the absolute abundance of each fluorophore associated with the target particle is calculated from the spectrally resolved light from each fluorophore. In certain embodiments, a particle may be identified or classified based on the relative abundance of each fluorophore determined to be associated with the particle. In these embodiments, the particle may be identified or classified by any convenient protocol such as by: comparing the relative or absolute abundance of each fluorophore associated with a particle with a control sample having particles of known identity; or by conducting spectroscopic or other assay analysis of a population of particles (e.g., cells) having the calculated relative or absolute abundance of associated fluorophores.

In certain embodiments, methods may include sorting one or more of the particles (e.g., cells) of the sample that are identified based on the estimated abundance of the fluorophores associated with the particle. The term “sorting” is used herein in its conventional sense to refer to separating components (e.g., droplets containing cells, droplets containing non-cellular particles such as biological macromolecules) of a sample and in some instances, delivering the separated components to one or more sample collection containers. For example, methods may include sorting 2 or more components of the sample, such as 3 or more components, such as 4 or more components, such as 5 or more components, such as 10 or more components, such as 15 or more components and including sorting 25 or more components of the sample. In sorting particles identified based on the abundance of fluorophores associated with the particle, methods include data acquisition, analysis and recording, such as with a computer, where multiple data channels record data from each detector used in obtaining the overlapping spectra of the plurality of fluorophore-biomolecule reagent pairs associated with the particle. In these embodiments, analysis includes spectrally resolving light (e.g., by calculating the spectral unmixing matrix) from the plurality of fluorophores of the fluorophore-biomolecule reagent pairs having overlapping spectra that are associated with the particle and identifying the particle based on the estimated abundance of each fluorophore associated with the particle. This analysis may be conveyed to a sorting system which is configured to generate a set of digitized parameters based on the particle classification. In some embodiments, methods for sorting components of a sample include sorting particles (e.g., cells in a biological sample), such as described in U.S. Pat. Nos. 3,960,449; 4,347,935; 4,667,830; 5,245,318; 5,464,581; 5,483,469; 5,602,039; 5,643,796; 5,700,692; 6,372,506 and 6,809,804, the disclosures of which are herein incorporated by reference. In some embodiments, methods include sorting components of the sample with a particle sorting module, such as those described in U.S. Pat. Nos. 9,551,643 and 10,324,019, U.S. Patent Publication No. 2017/0299493 and International Patent Publication No. WO/2017/040151, the disclosure of which is incorporated herein by reference. In certain embodiments, cells of the sample are sorted using a sort decision module having a plurality of sort decision units, such as those described in U.S. Pat. No. 11,085,868, the disclosure of which is incorporated herein by reference.

Flow cytometric assay procedures are well known in the art. See, e.g., Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain aspects, flow cytometrically assaying a composition involves using a flow cytometer capable of simultaneous excitation and detection of multiple fluorophores, such as a BD Biosciences FACSCanto™ flow cytometer, used substantially according to the manufacturer's instructions. Methods of the present disclosure may involve image cytometry, such as is described in Holden et al. (2005) Nature Methods 2:773 and Valet, et al. 2004 Cytometry 59:167-171, the disclosures of which are incorporated herein by reference.

Suitable flow cytometry systems may include, but are not limited to, those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ flow cytometer, BD Biosciences FACSCanto™ II flow cytometer, BD Accuri™ flow cytometer, BD Accuri™ C6 Plus flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer, BD Biosciences LSRFortessa™ flow cytometer, BD Biosciences LSRFortessa™ X-20 flow cytometer, BD Biosciences FACSPresto™ flow cytometer, BD Biosciences FACSVia™ flow cytometer and BD Biosciences FACSCalibur™ cell sorter, a BD Biosciences FACSCount™ cell sorter, BD Biosciences FACSLyric™ cell sorter, BD Biosciences Via™ cell sorter, BD Biosciences Influx™ cell sorter, BD Biosciences Jazz™ cell sorter, BD Biosciences Aria™ cell sorter, BD Biosciences FACSAria™ II cell sorter, BD Biosciences FACSAria™ III cell sorter, BD Biosciences FACSAria™ Fusion cell sorter and BD Biosciences FACSMelody™ cell sorter, BD Biosciences FACSymphony™ S6 cell sorter or the like.

In some embodiments, subject methods comprise applying flow cytometric systems, such those described in U.S. Pat. Nos. 10,663,476; 10,620,111; 10,613,017; 10,605,713; 10,585,031; 10,578,542; 10,578,469; 10,481,074; 10,302,545; 10,145,793; 10,113,967; 10,006,852; 9,952,076; 9,933,341; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; 4,987,086; 4,498,766; the disclosures of which are herein incorporated by reference in their entirety.

In certain instances, flow cytometry systems of the invention are configured for imaging particles in a flow stream by fluorescence imaging using radiofrequency tagged emission (FIRE), such as those described in Diebold, et al. Nature Photonics Vol. 7(10); 806-810 (2013) as well as described in U.S. Pat. Nos. 9,423,353; 9,784,661; 9,983,132; 10,006,852; 10,078,045; 10,036,699; 10,222,316; 10,288,546; 10,324,019; 10,408,758; 10,451,538; 10,620,111; and U.S. Patent Publication Nos. 2017/0133857; 2017/0328826; 2017/0350803; 2018/0275042; 2019/0376895 and 2019/0376894 the disclosures of which are herein incorporated by reference. Image data may comprise flow cytometric data obtained via a FIRE protocol, e.g., with a FACSDiscover flow cytometer, such as described in Schraivogel et al., Science Vol. 375(6578); 315-320 (2022), of a labeled particle, e.g., cell, in accordance with embodiments of the invention. Image data may be obtained in part from fluorophores that have little impact on other detector, such as, for example, conjugated polymeric dyes BB515, BB550 and BB790 (BD Biosciences).

### Imaging Flow Cytometry:

In connection with obtaining cytometric imaging data for analysis (and ultimately for presentation in reports, such as batch reports described herein), in certain instances, as described above, the flow stream is irradiated with a plurality of beams of frequency-shifted light and a particle, e.g., a cell, in the flow stream is imaged by fluorescence imaging using radiofrequency tagged emission (FIRE) to generate a frequency-encoded image, such as those described in Diebold, et al., Nature Photonics Vol. 7(10); 806-810 (2013), as well as described in U.S. Pat. Nos. 9,423,353; 9,784,661; 9,983,132; 10,006,852; 10,078,045; 10,036,699; 10,222,316; 10,288,546; 10,324,019; 10,408,758; 10,451,538; 10,620,111; and U.S. Patent Publication Nos. 2017/0133857; 2017/0328826; 2017/0350803; 2018/0275042; 2019/0376895 and 2019/0376894 the disclosures of which are herein incorporated by reference. In such instances, flow cytometric data may include image data of particles, e.g., cells present in the sample. See, e.g., Schraivogel et al., Science Vol. 375(6578); 315-320 (2022), the disclosure of which is incorporated herein in its entirety, as well as U.S. Provisional Patent Application Ser. No. 63/256,974), the disclosure of which is incorporated herein in its entirety.

### Computer-Implemented Embodiments

The various method and algorithm steps described in connection with the embodiments disclosed herein can be implemented as electronic hardware, computer software, or combinations of both. To clearly illustrate this interchangeability of hardware and software, various illustrative steps have been described above generally in terms of their functionality. Whether such functionality is implemented as hardware or software depends upon the particular application and design constraints imposed on the overall system applying a method according to the present disclosure. The described functionality can be implemented in varying ways for each particular application, but such implementation decisions should not be interpreted as causing a departure from the scope of the disclosure.

The various illustrative steps, components, and computing systems (such as devices, databases, interfaces, and engines) described in connection with the embodiments disclosed herein can be implemented or performed by a machine, such as a general purpose processor, a graphics processor unit, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor can also include primarily analog components. A computing environment can include any type of computer system, including, but not limited to, a computer system based on a microprocessor, a graphics processor unit, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module, engine, and associated databases can reside in memory resources such as in RAM memory, FRAM memory, flash memory, ROM memory, EPROM memory, EEPROM memory, registers, hard disk, a removable disk, a CD-ROM, or any other form of non-transitory computer-readable storage medium, media, or physical computer storage known in the art. An external storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

### Systems

As summarized above, aspects of the present disclosure include systems for practicing the subject methods. Systems according to certain embodiments comprise a processor comprising memory operably coupled to the processor, wherein the memory comprises instructions stored thereon, which, when executed by the processor, cause the processor to: receive input from an input device specifying a configuration of a report template, generate, based on the configuration received from the input device, the report template, receive input from the input device specifying a source group and an iterator type, wherein the source group comprises a plurality of data sets, and the iterator type corresponds to a type of data present in the source group, iteratively populate a plurality of batch reports using the plurality of data sets of the source group, based on the iterator type, wherein each batch report conforms to the report template and is populated with a separate data set of the plurality of data sets of the source group, and outputting, to an output device, the plurality of batch reports to the output device, wherein the processor and the memory are operably connected to each of the input device and the output device.

Systems according to some embodiments, may include a display and operator input device. Operator input devices may, for example, be a keyboard, mouse, or the like. The processing module includes at least one general purpose processor as well as a plurality of parallel processing units, all of which have access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The general purpose processor as well as each of the parallel processing units may be a commercially available processor, or it may be one of other processors that are or will become available. The processors execute the operating system, and the operating system interfaces with firmware and hardware in a well-known manner and facilitates the processors in coordinating and executing the functions of various computer programs that may be written in a variety of programming languages, such as Java, Perl, Python, R, Go, JavaScript, .NET, CUDA, Verilog, C++, other high level or low-level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. The processors may be any suitable analog or digital systems. In some embodiments, the one or more general purpose processors as well as the parallel processing units include analog electronics which provide feedback control, such as for example negative feedback control.

The system memory may be any of a variety of known or future memory storage devices. Examples include any commonly available random-access memory (RAM), magnetic medium such as a resident hard disk or tape, an optical medium such as a read and write compact disc, flash memory devices, or other memory storage device. The memory storage device may be any of a variety of known or future devices, including a compact disc drive, a tape drive, a removable hard disk drive, or a diskette drive. Such types of memory storage devices typically read from, and/or write to, a program storage medium (not shown) such as, respectively, a compact disc, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor of the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the one or more general purpose processors as well as the plurality of parallel processing units, such as a graphics processor, can store and retrieve data, such as magnetic, optical, or solid-state storage devices (including magnetic or optical disks or tape or RAM, or any other suitable device, either fixed or portable). The general purpose processor may include a general-purpose digital microprocessor suitably programmed from a computer readable medium carrying necessary program code. The parallel processing units may include one or more graphics processors suitably programmed from a computer readable medium carrying necessary program code. Programming can be provided remotely to the processors through one or more communication channels, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The one or more general purpose processors may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra-Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, an RS-232 port, or any other suitable electrical connection port to allow data communication between the subject systems and other external devices such as a computer terminal (for example, at a physician's office or in hospital environment) that is configured for similar complementary data communication.

In one embodiment, the communication interface is configured for infrared communication, Bluetooth® communication, or any other suitable wireless communication protocol to enable the subject systems to communicate with other devices such as computer terminals and/or networks, communication enabled mobile telephones, personal digital assistants, or any other communication devices which the user may use in conjunction.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or WiFi connection to the internet at a WiFi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via a system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located, or they may be physically separated. Various operating systems may be employed on any of the computer platforms, possibly depending on the type and/or make of computer platform chosen. Appropriate operating systems include Windows 10, Windows NT^{□}, Windows XP, Windows 7, Windows 8, iOS, Oracle Solaris, Linux, OS/400, Compaq Tru64 Unix, SGI IRIX, Siemens Reliant Unix, Ubuntu, Zorin OS and others.

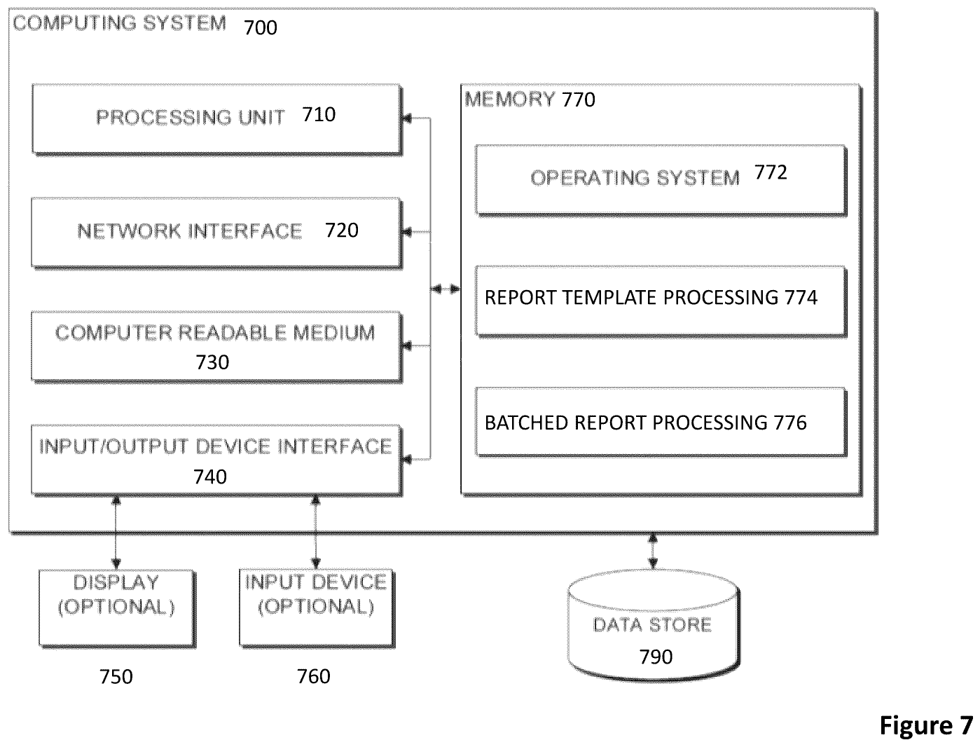

FIG. 7 depicts a general architecture of an example computing device 700 according to certain embodiments. The general architecture of the computing device 700 depicted in FIG. 7 includes an arrangement of computer hardware and software components. The computing device 700 may include many more (or fewer) elements than those shown in FIG. 7. It is not necessary, however, that all of these generally conventional elements be shown in order to provide an enabling disclosure. As illustrated, the computing device 700 includes a processing unit 710, a network interface 720, a computer readable medium drive 730, an input/output device interface 740, a display 750, and an input device 760, all of which may communicate with one another by way of a communication bus. The network interface 720 may provide connectivity to one or more networks or computing systems. The processing unit 710 may thus receive information and instructions from other computing systems or services via a network. The processing unit 710 may also communicate to and from memory 770 and further provide output information for an optional display 750 via the input/output device interface 740. The input/output device interface 740 may also accept input from the optional input device 760, such as a keyboard, mouse, digital pen, microphone, touch screen, gesture recognition system, voice recognition system, gamepad, accelerometer, gyroscope, or other input device.

The memory 770 may contain computer program instructions (grouped as modules or components in some embodiments) that the processing unit 710 executes in order to implement one or more embodiments. The memory 770 generally includes RAM, ROM and/or other persistent, auxiliary or non-transitory computer-readable media. The memory 770 may store an operating system 772 that provides computer program instructions for use by processing unit 710 in the general administration and operation of the computing device 700. The memory 770 may further include computer program instructions and other information for implementing aspects of the present disclosure.

For example, in one embodiment, the memory 770 includes a report template processing module 774 for generating one or more aspects of a report template, such as those described above, as well as batched report processing module 776 for generating batched reports by populating instances of report templates with applicable data.

### Computer-Readable Storage Mediums

Aspects of the present disclosure further include non-transitory computer readable storage mediums having instructions for practicing the subject methods. Computer readable storage mediums may be employed on one or more computers for complete automation or partial automation of a system for practicing methods described herein. In certain embodiments, instructions in accordance with the method described herein can be coded onto a computer-readable medium in the form of “programming,” where the term “computer readable medium” as used herein refers to any non-transitory storage medium that participates in providing instructions and data to a computer for execution and processing. Examples of suitable non-transitory storage media include a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS), whether or not such devices are internal or external to the computer. A file containing information can be “stored” on a computer readable medium, where “storing” means recording information such that it is accessible and retrievable at a later date by a computer. The computer-implemented method described herein can be executed using programming that can be written in one or more of any number of computer programming languages. Such languages include, for example, Java (Sun Microsystems, Inc., Santa Clara, CA), Visual Basic (Microsoft Corp., Redmond, WA), C++ (AT&T Corp., Bedminster, NJ), Python, as well as any many others.

In some embodiments, computer readable storage media of interest include a computer program stored thereon, where the computer program when loaded on the computer includes instructions having: algorithm for generating, based on input from a user, a report template, algorithm for selecting, based on input from the user, a source group and an iterator type, wherein the source group comprises a plurality of data sets, and the iterator type corresponds to a type of data present in the source group, and algorithm for iteratively populating a plurality of batch reports using the plurality of data sets of the source group, based on the iterator type, wherein each batch report conforms to the report template and is populated with a separate data set of the plurality of data sets of the source group.

### Utility

The subject systems, methods and non-transitory computer readable storage mediums find use in a variety of applications where it is desirable to visualize data, such as large data sets or large numbers of data sets. For example, embodiments find use in visualizing data obtained using a flow cytometer to analyze one or more samples. Subject systems, methods and non-transitory computer readable storage mediums find use in applications where presentations or reports for presenting data, such as results of analysis using a flow cytometer, are desired. Subject systems, methods and non-transitory computer readable storage mediums find use in applications involving conducting one or more experimental processes with one or more control groups and one or more experimental groups, where it is desirable that the results associated with each such group are separately displayed using any convenient data visualization technique for analysis of experimental results.

The following is offered by way of illustration and not by way of limitation.

### Experimental

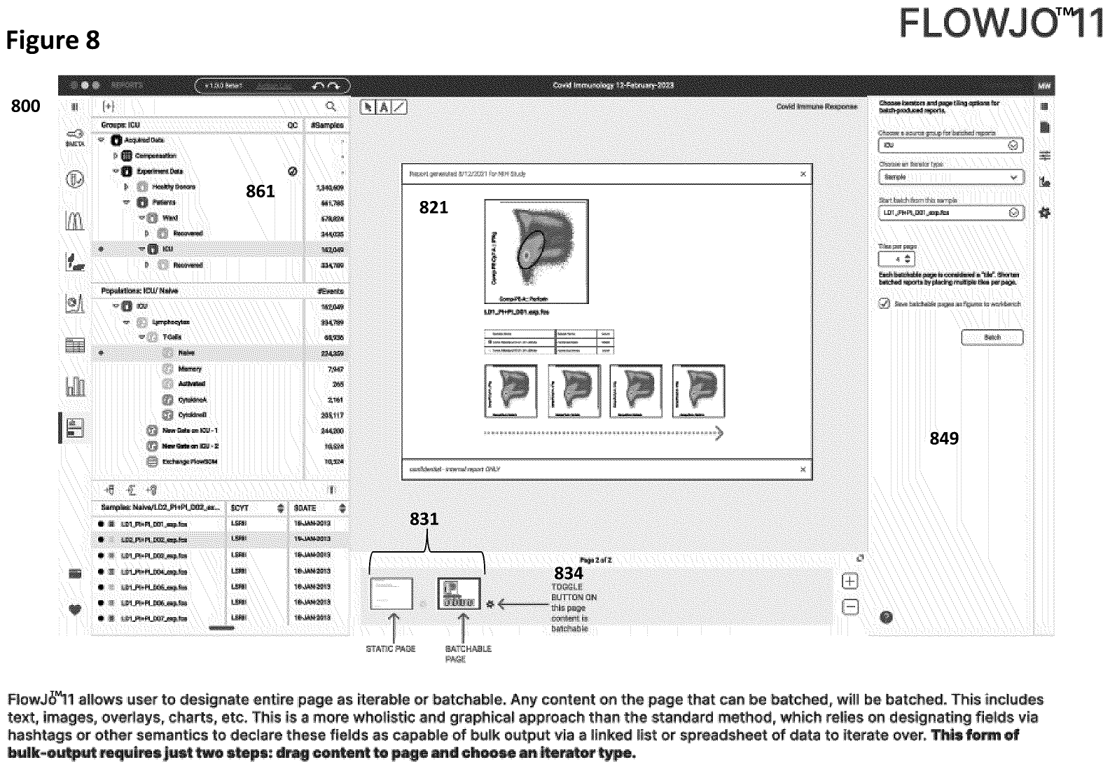

FIG. 8 shows an excerpt of a user interface 800 for configuring report template 821 as well as aspects of presentation 831 via menu 861, interface 849 and static/batchable toggle button 834. Excerpt of user interface 800 is an excerpt from an embodiment of FlowJo™ 11 software from Becton, Dickinson and Company. Such software is designed to enable the user to designate an entire page, such as a page of presentation 831 corresponding to report template 821, as batchable (also referred to as iterable). In contrast to mail merge examples 110 and 150 shown in FIG. 1, any content on presentation 831 page that comprises report template 821 that can be batched, will be batched upon generation of report template 821 and clicking a “Batch” button of interface 849. That is, any content on report template 821 capable of receiving data from a data set of the source group will be populated with such data. In embodiments, batchable content includes text, images, overlays, charts and the like, generated and configured by the user interacting with interface 800. Again, in contrast to mail merge examples 110 and 150 shown in FIG. 1, embodiments of the present invention, such as that shown in FIG. 8, do not rely on designating fields using hashtags or other semantics to declare such fields capable of bulk output from iterating over data stored in, for example, a linked list or a spreadsheet. Instead, embodiments of the present invention require the user to generate report template 821 as well as select an iterator type for iterating over data sets of a source group.

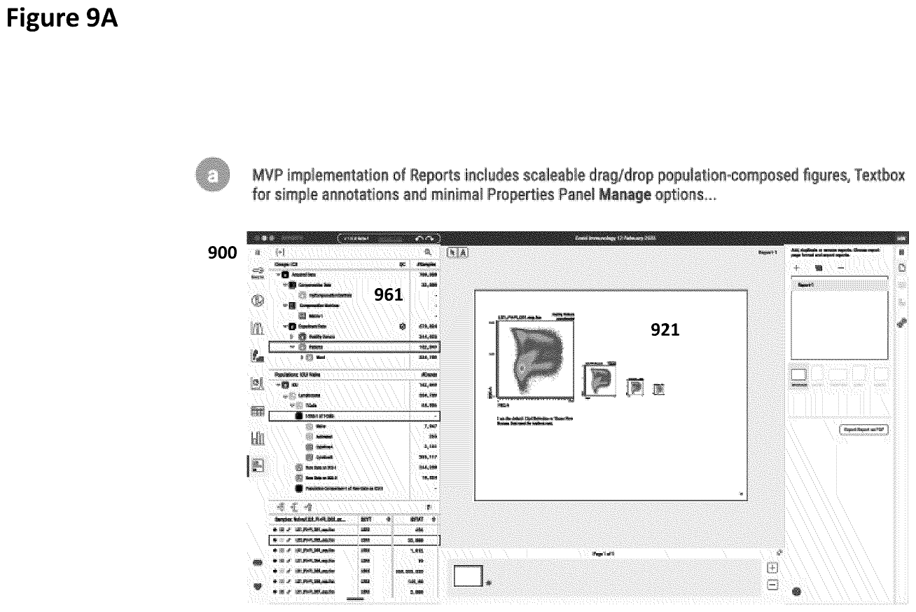

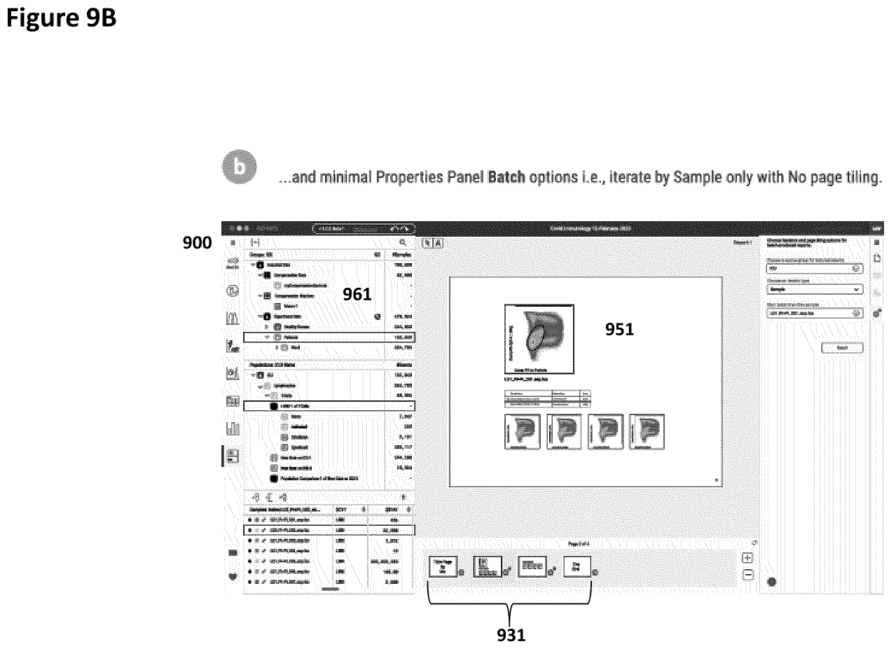

FIGS. 9A-B show examples of generating a report template and using such template to automatically generate batch reports in a presentation according to an embodiment of the present invention. In FIG. 9A, interface 900 shows report template 921, generated by a user using tools available via interface 901, such as scalable drag and drop features, including for example a plot or a textbox for simple annotations. The user is able to configure report template 921 by interacting with, for example, menu options 961. FIG. 9B shows interface 900 displaying the results of automatically generating batch reports, including presentation 931 which includes a plurality of batched (i.e., automatically generated) reports including batched (i.e., automatically generated) report 951, which is highlighted and expanded in interface 900 for further configuration as desired by the user. Batched reports 931 seen in FIG. 9B were generated by iterating over a sample only. In addition, batched reports 931 seen in FIG. 9B were added to the presentation in a manner that includes no tiling. That is, one batched report is included on each page of presentation 931.

Notwithstanding the appended claims, the disclosure is also defined by the following clauses:

1. A computer-implemented method for automatically generating reports, the method comprising:
generating, based on input from a user, a report template;
selecting, based on input from the user, a source group and an iterator type, wherein the source group comprises a plurality of data sets, and the iterator type corresponds to a type of data present in the source group; and
iteratively populating a plurality of batch reports using the plurality of data sets of the source group, based on the iterator type, wherein each batch report conforms to the report template and is populated with a separate data set of the plurality of data sets of the source group.
   2. The computer-implemented method of clause 1, wherein the report template comprises a data visualization structure.
   3. The computer-implemented method of clause 2, wherein the data visualization structure comprises: an image, a plot, a chart, a table, a legend or text.
   4. The computer-implemented method of clause 3, wherein the image is an image of a cell.
   5. The computer-implemented method of any of clauses 2 to 4, wherein generating, based on input from a user, a report template comprises receiving from the user a configuration of the data visualization structure.
   6. The computer-implemented method of any of the previous clauses, wherein iteratively populating the plurality of batch reports comprising automatically identifying aspects of the report template corresponding to the iterator type.
   7. The computer-implemented method of any of the previous clauses, wherein the report template is configured to present flow cytometric data.
   8. The computer-implemented method of any of the previous clauses, wherein each data set of the source group comprises flow cytometric data.
   9. The computer-implemented method of clause 8, wherein the flow cytometric data comprises light scatter or marker data or a combination thereof.
   10. The computer-implemented method according to clause 9, wherein the light scatter data comprises forward scattered light or side scattered light or a combination thereof.
   11. The computer-implemented method according to any of clauses 9 to 10, wherein the marker data comprises fluorescent light emission data.
   12. The computer-implemented method according to any of clauses 8 to 11, wherein the flow cytometric data comprises data obtained by flow cytometrically analyzing a sample.
   13. The computer-implemented method of clause 12, wherein each data set of the source group comprises flow cytometric data corresponding to a different sample.
   14. The computer-implemented method of clause 12, wherein each data set of the source group comprises flow cytometric data corresponding to a different statistic.
   15. The computer-implemented method of clause 12, wherein each data set of the source group comprises flow cytometric data corresponding to different measurements.
   16. The computer-implemented method of clause 12, wherein each data set of the source group comprises flow cytometric data corresponding to a different interval.
   17. The computer-implemented method of any of the previous clauses, further comprising receiving a data set of the source group.
   18. The computer-implemented method of any of the previous clauses, wherein selecting the source group comprises selecting a source group from a drop-down menu.
   19. The computer-implemented method of any of the previous clauses, wherein the iterator type identifies a category of data present in the source group.
   20. The computer-implemented method of any of the previous clauses, wherein the iterator type identifies a category of data that may vary across the plurality of data sets of the source group.
   21. The computer-implemented method of any of the previous clauses, wherein the iterator type selects the type of data used to populate the plurality of batch reports.
   22. The computer-implemented method of any of the previous clauses, wherein the iterator type selects the type of data that varies across the plurality of batch reports.
   23. The computer-implemented method of any of the previous clauses, wherein batch reports are iteratively populated by iterator type.
   24. The computer-implemented method of any of the previous clauses, wherein the iterator type determines whether batch reports are iteratively populated by sample, by keyword, by statistic or by interval.
   25. The computer-implemented method of clause 24, wherein iteratively populating batch reports by sample comprises iterating over samples of the source group.
   26. The computer-implemented method of clause 24, wherein iteratively populating batch reports by keyword comprises iterating over keywords of the source group.
   27. The computer-implemented method of clause 24, wherein iteratively populating batch reports by interval comprises iterating over intervals of the source group.
   28. The computer-implemented method of clause 24, wherein iteratively populating batch reports by statistic comprises iterating over statistics of the source group.
   29. The computer-implemented method of any of the previous clauses, wherein selecting the iterator type comprises the user selecting an iterator type from a drop-down menu.
   30. The computer-implemented method of any of the previous clauses, further comprising selecting a number of reports to include on a presentation page.
   31. The computer-implemented method of any of the previous clauses, further comprising generating, based on input from a user, static content.
   32. The computer-implemented method of clause 31, wherein the static content is not automatically populated.
   33. The computer-implemented method of any of the previous clauses, further comprising designating, based on input from a user, that aspects of a presentation page comprise a report template.
   34. The computer-implemented method of any of the previous clauses, further comprising designating, based on input from a user, that aspects of a presentation page comprise static content.
   35. A system for automatically generating reports, the system comprising:
a processor comprising memory operably coupled to the processor, wherein the memory comprises instructions stored thereon, which, when executed by the processor, cause the processor to:
   receive input from an input device specifying a configuration of a report template;
   generate, based on the configuration received from the input device, the report template;
   receive input from the input device specifying a source group and an iterator type, wherein the source group comprises a plurality of data sets, and the iterator type corresponds to a type of data present in the source group;
   iteratively populate a plurality of batch reports using the plurality of data sets of the source group, based on the iterator type, wherein each batch report conforms to the report template and is populated with a separate data set of the plurality of data sets of the source group; and
   outputting, to an output device, the plurality of batch reports to the output device,
wherein the processor and the memory are operably connected to each of the input device and the output device.
   36. The system of clause 35, wherein the report template comprises a data visualization structure.
   37. The system of clause 36, wherein the data visualization structure comprises: an image, a plot, a chart, a table, a legend or text.
   38. The system of clause 37, wherein the image is an image of a cell.
   39. The system of any of clauses 36 to 38, wherein generate, based on the configuration received from the input device, the report template comprises receiving from the input device a configuration of the data visualization structure.
   40. The system of any of clauses 35 to 39, wherein iteratively populate a plurality of batch reports comprises automatically identifying aspects of the report template corresponding to the iterator type.
   41. The system of any of clauses 35 to 40, wherein the report template is configured to present flow cytometric data.
   42. The system of any of clauses 35 to 41, wherein each data set of the source group comprises flow cytometric data.
   43. The system of clause 42, wherein the flow cytometric data comprises light scatter or marker data or a combination thereof.
   44. The system of clause 43, wherein the light scatter data comprises forward scattered light or side scattered light or a combination thereof.
   45. The system of any of clauses 43 to 44, wherein the marker data comprises fluorescent light emission data.
   46. The system of any of clauses 42 to 45, wherein the flow cytometric data comprises data obtained by flow cytometrically analyzing a sample.
   47. The system of clause 46, wherein each data set of the source group comprises flow cytometric data corresponding to a different sample.
   48. The system of clause 46, wherein each data set of the source group comprises flow cytometric data corresponding to a different statistic.
   49. The system of clause 46, wherein each data set of the source group comprises flow cytometric data corresponding to different measurements.
   50. The system of clause 46, wherein each data set of the source group comprises flow cytometric data corresponding to a different interval.
   51. The system of any of clauses 35 to 50, wherein the memory further comprises instructions stored thereon, which, when executed by the processor, cause the processor to receive, from the input device, a data set of the source group.
   52. The system of any of clauses 35 to 51, wherein specifying a source group comprises receiving input based on selecting the source group from a drop-down menu.
   53. The system of any of clauses 35 to 52, wherein the iterator type identifies a category of data present in the source group.
   54. The system of any of clauses 35 to 53, wherein the iterator type identifies a category of data that may vary across the plurality of data sets of the source group.
   55. The system of any of clauses 35 to 54, wherein the iterator type selects the type of data used to populate the plurality of batch reports.
   56. The system of any of clauses 35 to 55, wherein the iterator type selects the type of data that varies across the plurality of batch reports.
   57. The system of any of clauses 35 to 56, wherein batch reports are iteratively populated by iterator type.
   58. The system of any of clauses 35 to 57, wherein the iterator type determines whether batch reports are iteratively populated by sample, by keyword, by statistic or by interval.
   59. The system of clause 58, wherein iteratively populating batch reports by sample comprises iterating over samples of the source group.
   60. The system of clause 58, wherein iteratively populating batch reports by keyword comprises iterating over keywords of the source group.
   61. The system of clause 58, wherein iteratively populating batch reports by statistic comprises iterating over statistics of the source group.
   62. The system of clause 58, wherein iteratively populating batch reports by statistic comprises iterating over intervals of the source group.
   63. The system of any of clauses 35 to 62, wherein specifying the iterator type comprises selecting an iterator type from a drop-down menu.
   64. The system of any of clauses 35 to 63, wherein the memory further comprises instructions stored thereon, which, when executed by the processor, cause the processor to receive, from the input device, a selection of a number of reports to include on a presentation page.
   65. The system of any of clauses 35 to 64, wherein the memory further comprises instructions stored thereon, which, when executed by the processor, cause the processor to generate, based on input from a user, static content.
   66. The system of any of clauses 35 to 65, wherein the static content is not automatically populated.
   67. The system of any of clauses 35 to 66, wherein the memory further comprises instructions stored thereon, which, when executed by the processor, cause the processor to receive, from the input device, a designation that aspects of a presentation page comprise a report template.
   68. The system of any of clauses 35 to 67, wherein the memory further comprises instructions stored thereon, which, when executed by the processor, cause the processor to receive, from the input device, a designation that aspects of a presentation page comprise static content.
   69. The system of any of clauses 35 to 68, further comprising the input device and the output device.
   70. A non-transitory computer readable storage medium comprising instructions stored thereon for automatically generating reports, the instructions comprising:
algorithm for generating, based on input from a user, a report template;
algorithm for selecting, based on input from the user, a source group and an iterator type, wherein the source group comprises a plurality of data sets, and the iterator type corresponds to a type of data present in the source group; and
algorithm for iteratively populating a plurality of batch reports using the plurality of data sets of the source group, based on the iterator type, wherein each batch report conforms to the report template and is populated with a separate data set of the plurality of data sets of the source group.
   71. The non-transitory computer readable storage medium of clause 70, wherein the report template comprises a data visualization structure.
   72. The non-transitory computer readable storage medium of clause 71, wherein the data visualization structure comprises: an image, a plot, a chart, a table, a legend or text.
   73. The non-transitory computer readable storage medium of clause 72, wherein the image is an image of a cell.
   74. The non-transitory computer readable storage medium of clauses 71 to 73, wherein algorithm for generating, based on input from a user, a report template comprises algorithm for receiving from the user a configuration of the data visualization structure.
   75. The non-transitory computer readable storage medium of clauses 70 to 74, wherein algorithm for iteratively populating the plurality of batch reports comprises algorithm for automatically identifying aspects of the report template corresponding to the iterator type.
   76. The non-transitory computer readable storage medium of clauses 70 to 75, wherein the report template is configured to present flow cytometric data.
   77. The non-transitory computer readable storage medium of clauses 70 to 76, wherein each data set of the source group comprises flow cytometric data.
   78. The non-transitory computer readable storage medium of clause 77, wherein the flow cytometric data comprises light scatter or marker data or a combination thereof.
   79. The non-transitory computer readable storage medium of clause 78, wherein the light scatter data comprises forward scattered light or side scattered light or a combination thereof.
   80. The non-transitory computer readable storage medium of any of clauses 78 to 79, wherein the marker data comprises fluorescent light emission data.
   81. The non-transitory computer readable storage medium of any of clauses 77 to 80, wherein the flow cytometric data comprises data obtained by flow cytometrically analyzing a sample.
   82. The non-transitory computer readable storage medium of clause 81, wherein each data set of the source group comprises flow cytometric data corresponding to a different sample.
   83. The non-transitory computer readable storage medium of clause 81, wherein each data set of the source group comprises flow cytometric data corresponding to a different statistic.
   84. The non-transitory computer readable storage medium of clause 81, wherein each data set of the source group comprises flow cytometric data corresponding to different measurements.
   85. The non-transitory computer readable storage medium of clause 81, wherein each data set of the source group comprises flow cytometric data corresponding to a different interval.
   86. The non-transitory computer readable storage medium of any of clauses 70 to 85, further comprising algorithm for receiving a data set of the source group.
   87. The non-transitory computer readable storage medium of any of clauses 70 to 86, wherein algorithm for selecting the source group comprises algorithm for selecting a source group from a drop-down menu.
   88. The non-transitory computer readable storage medium of any of clauses 70 to 87, wherein the iterator type identifies a category of data present in the source group.
   89. The non-transitory computer readable storage medium of any of clauses 70 to 88, wherein the iterator type identifies a category of data that may vary across the plurality of data sets of the source group.
   90. The non-transitory computer readable storage medium of any of clauses 70 to 89, wherein the iterator type selects the type of data used to populate the plurality of batch reports.
   91. The non-transitory computer readable storage medium of any of clauses 70 to 90, wherein the iterator type selects the type of data that varies across the plurality of batch reports.
   92. The non-transitory computer readable storage medium of any of clauses 70 to 91, wherein batch reports are iteratively populated by iterator type.
   93. The non-transitory computer readable storage medium of any of clauses 70 to 92, wherein the iterator type determines whether batch reports are iteratively populated by sample, by keyword, by statistic or by interval.
   94. The non-transitory computer readable storage medium of clause 93, wherein algorithm for iteratively populating batch reports by sample comprises algorithm for iterating over samples of the source group.
   95. The non-transitory computer readable storage medium of clause 93, wherein algorithm for iteratively populating batch reports by keyword comprises algorithm for iterating over keywords of the source group.
   96. The non-transitory computer readable storage medium of clause 93, wherein algorithm for iteratively populating batch reports by interval comprises algorithm for iterating over intervals of the source group.
   97. The non-transitory computer readable storage medium of any of clause 93, wherein algorithm for iteratively populating batch reports by statistic comprises algorithm for iterating over statistics of the source group.
   98. The non-transitory computer readable storage medium of any of clauses 70 to 97, wherein algorithm for selecting the iterator type comprises algorithm for receiving a selection by the user for an iterator type from a drop-down menu.
   99. The non-transitory computer readable storage medium of any of clauses 70 to 98, further comprising algorithm for selecting a number of reports to include on a presentation page.
   100. The non-transitory computer readable storage medium of any of clauses 70 to 98, further comprising algorithm for generating, based on input from a user, static content.
   101. The non-transitory computer readable storage medium of clause 100, wherein the static content is not automatically populated.
   102. The non-transitory computer readable storage medium of any of clauses 70 to 101, further comprising algorithm for designating, based on input from a user, that aspects of a presentation page comprise a report template.
   103. The non-transitory computer readable storage medium of any of clauses 70 to 102, further comprising algorithm for designating, based on input from a user, that aspects of a presentation page comprise static content.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112(f) or 35 U.S.C. § 112(6) is not invoked.

1. A computer-implemented method for automatically generating reports, the method comprising:
generating, based on input from a user, a report template;
selecting, based on input from the user, a source group and an iterator type, wherein the source group comprises a plurality of data sets, and the iterator type corresponds to a type of data present in the source group; and
iteratively populating a plurality of batch reports using the plurality of data sets of the source group, based on the iterator type, wherein each batch report conforms to the report template and is populated with a separate data set of the plurality of data sets of the source group.

2. The computer-implemented method of claim 1, wherein the report template comprises a data visualization structure.

3. The computer-implemented method of claim 2, wherein the data visualization structure comprises: an image, a plot, a chart, a table, a legend or text.

4. The computer-implemented method of claim 3, wherein the image is an image of a cell.

5. The computer-implemented method of claim 2, wherein generating, based on input from a user, a report template comprises receiving from the user a configuration of the data visualization structure.

6. The computer-implemented method of claim 1, wherein iteratively populating the plurality of batch reports comprising automatically identifying aspects of the report template corresponding to the iterator type.

7. The computer-implemented method of claim 1, wherein the report template is configured to present flow cytometric data.

8. The computer-implemented method of claim 1, wherein each data set of the source group comprises flow cytometric data.

9-16. (canceled)

17. The computer-implemented method of claim 1, further comprising receiving a data set of the source group.

18. The computer-implemented method of claim 1, wherein selecting the source group comprises selecting a source group from a drop-down menu.

19. The computer-implemented method of claim 1, wherein the iterator type identifies a category of data present in the source group.

20. The computer-implemented method of claim 1, wherein the iterator type identifies a category of data that may vary across the plurality of data sets of the source group.

21. The computer-implemented method of claim 1, wherein the iterator type selects the type of data used to populate the plurality of batch reports.

22. The computer-implemented method of claim 1, wherein the iterator type selects the type of data that varies across the plurality of batch reports.

23. The computer-implemented method of claim 1, wherein batch reports are iteratively populated by iterator type.

24. The computer-implemented method of claim 1, wherein the iterator type determines whether batch reports are iteratively populated by sample, by keyword, by statistic or by interval.

25-28. (canceled)

29. The computer-implemented method of claim 1, wherein selecting the iterator type comprises the user selecting an iterator type from a drop-down menu.

30. The computer-implemented method of claim 1, further comprising selecting a number of reports to include on a presentation page.

31. The computer-implemented method of claim 1, further comprising generating, based on input from a user, static content.

32. (canceled)

33. The computer-implemented method of claim 1, further comprising designating, based on input from a user, that aspects of a presentation page comprise a report template.

34. The computer-implemented method of claim 1, further comprising designating, based on input from a user, that aspects of a presentation page comprise static content.

35-103. (canceled)
